(19) United States
(12) Patent Application Publication
(10) Pub. No.: US 2026/0192737 A1
(43) Pub. Date: Jul. 9, 2026

(54) Load Restraint Strips with Lengthwise Perforations and/or without Adhesive Region Release Liner

(71) Applicant: MBull Holdings, LLC, North Miami Beach, FL (US)

(72) Inventor: Matthew Bullock, McLean, VA (US)

(21) Appl. No.: 19/079,096

(22) Filed: Mar. 13, 2025

Related U.S. Application Data
(63) Continuation-in-part of application No. 19/013,471, filed on Jan. 8, 2025.

(51) Int. Cl. B60P 7/14

(52) U.S. Cl. CPC B60P 7/14

(57) ABSTRACT

Load restraint strips used to secure loads in a cargo container may comprise separation zones. A separation zone of a load restraint strip may be severed during removal of an attachment region of that load restraint strip from a cargo container wall. This allows removing portions of the load restraint strip separately, thereby reducing force needed to peel an attachment region away from a cargo container wall.

### CROSS-REFERENCE TO RELATED APPLICATION

This application is a continuation-in-part of U.S. patent application Ser. No. 19/013,471, titled “Securing Cargo Using Load Restraint Strips Secured Via Previously-Affixed Load Restraint Strip Attachment Regions” and filed Jan. 8, 2025, which application in its entirety is incorporated by reference herein.

### BACKGROUND

Shipping containers such as truck trailers and intermodal containers can be loaded with boxes, crates, drums, reinforced bags, plastic wrapped bundles, cased goods, metal coils, specialty heavy paper rolls, plastic or metal containers mounted on pallets, and/or numerous other forms of cargo. Numerous transportation regulations require that such loads be restrained from shifting. Load restraint strips can be used to secure cargo within a shipping container. Each load restraint strip may be flexible and have an adhesive-coated end that is pressed into contact with an interior side wall of the container. The other ends of the load restraint strips may then be wrapped around cargo, tightened, and secured with an adhesive-backed patch applied over the tightened ends. Conventionally, load restraint strips have been removed after each use so that load restraint strips for the next load may be attached directly to the interior walls of the shipping container. This can become very time-consuming, particularly for shipping containers that are frequently loaded and unloaded. Also, removal of the adhesive-coated end of a load restraint strip from a shipping container wall may require significant pulling force.

### SUMMARY

This Summary is provided to introduce a selection of some concepts in a simplified form as a prelude to the Detailed Description. This Summary is not intended to identify key or essential features.

Load restraint strips used to secure a load in a cargo container may comprise separation zones that extend lengthwise along the load restraint strips. A separation zone may comprise one or more rows of perforations in a backing of a load restraint strip. A separation zone of a load restraint strip may also lack reinforcement strands that extend lengthwise along the load restraint strip in regions outside of the separation zone. A separation zone of a load restraint strip may be severed by pulling on the load restraint strip, thereby splitting regions of the load restraint strip in separate pieces along the lengthwise direction. A separation zone of a load restraint strip may be severed during removal of an attachment region of that load restraint strip from a cargo container wall. This allows removing pieces of the load restraint strip separately, thereby reducing force needed to peel an attachment region away from a cargo container wall.

These and other features are described in more detail below.

### BRIEF DESCRIPTION OF THE DRAWINGS

Some features are shown by way of example, and not by way of limitation, in the figures of the accompanying drawings and in which like reference numerals refer to similar elements.

FIGS. 1A, 1B, 1C, 1D, 1E, 1F, 1G, 1H, 1I, 1J, 1K, 1L, and 1M show an example cargo container during various stages of an example method for securing multiple cargo loads using load restraint strips.

FIG. 2A is a partially schematic plan view showing an interior face of an example load restraint strip configured for layered application.

FIG. 2B is a partially schematic plan view showing an exterior face of the load restraint strip of FIG. 2A.

FIG. 2C is a partially schematic plan view showing the exterior face of the load restraint strip of FIG. 2A after removal of release paper liners.

FIG. 3A is a partially schematic, truncated cross-sectional view taken from the location indicated in FIG. 2B.

FIG. 3B is a partially schematic, truncated cross-sectional view taken from the location indicated in FIG. 2B.

FIG. 3C is a partially schematic, truncated cross-sectional view taken from the location indicated in FIG. 2B.

FIG. 3D is a partially schematic, truncated cross-sectional view taken from the location indicated in FIG. 2C.

FIG. 4 is a partially schematic, truncated cross-sectional view taken from the location indicated in FIG. 1L.

FIG. 5 is a partially schematic, truncated cross-sectional view taken from the location indicated in FIG. 1L after performance of additional cycles of steps described in connection with FIGS. 1A-1M.

FIGS. 6A and 6B are a flow chart showing steps of an example method for securing multiple cargo loads using load restraint strips, and in which load restraint strips to secure a subsequent load may be secured to a cargo container by affixation to portions of load restraint strips that secured a previous load.

FIG. 7A is a partially schematic plan view showing an interior face of an example load restraint strip that comprises a longitudinally-extending separation zone.

FIG. 7B is a partially schematic plan view showing an exterior face of the load restraint strip of FIG. 7A.

FIG. 7C is a partially schematic plan view showing the exterior face of the load restraint strip of FIG. 7A after removal of release paper liners.

FIG. 8A is an enlarged view of the region indicated in FIG. 7A.

FIG. 8B is an enlarged view of the region indicated in FIG. 7B.

FIG. 8C is a partially schematic, truncated cross-sectional view taken from the location indicated in FIG. 7B.

FIG. 8D is a partially schematic, truncated cross-sectional view taken from the location indicated in FIG. 7B.

FIG. 8E is a partially schematic, truncated cross-sectional view taken from the location indicated in FIG. 7C.

FIG. 9 shows an example of how a separation zone may reduce pull force needed to remove an attachment region of a load restraint strip from a wall of a cargo container.

FIGS. 10A, 10B, 10C, 10D, 10E, 10F, 10G, and 10H show an example of how separation zones may reduce pull force needed to remove multiple layers of inter-bonded attachment regions.

FIGS. 11A and 11B show a roll of load restraint strips that are similar to the load restraint strips of FIGS. 2A-3D, but that lack release paper liners.

FIGS. 12A and 12B show a roll of load restraint strips that are similar to the load restraint strips of FIGS. 7A-8E, but that lack release paper liners.

FIG. 13A is a partially schematic plan view showing an interior face of an example load restraint strip that comprises a longitudinally-extending separation zone.

FIG. 13B is a partially schematic plan view showing an exterior face of the load restraint strip of FIG. 13A.

FIG. 13C is a partially schematic plan view showing the exterior face of the load restraint strip of FIG. 13A after removal of release paper liners.

FIG. 14A is a partially schematic, truncated cross-sectional view taken from the location indicated in FIG. 13B.

FIG. 14B is a partially schematic, truncated cross-sectional view taken from the location indicated in FIG. 13B.

FIG. 14C is a partially schematic, truncated cross-sectional view taken from the location indicated in FIG. 13C.

### DETAILED DESCRIPTION

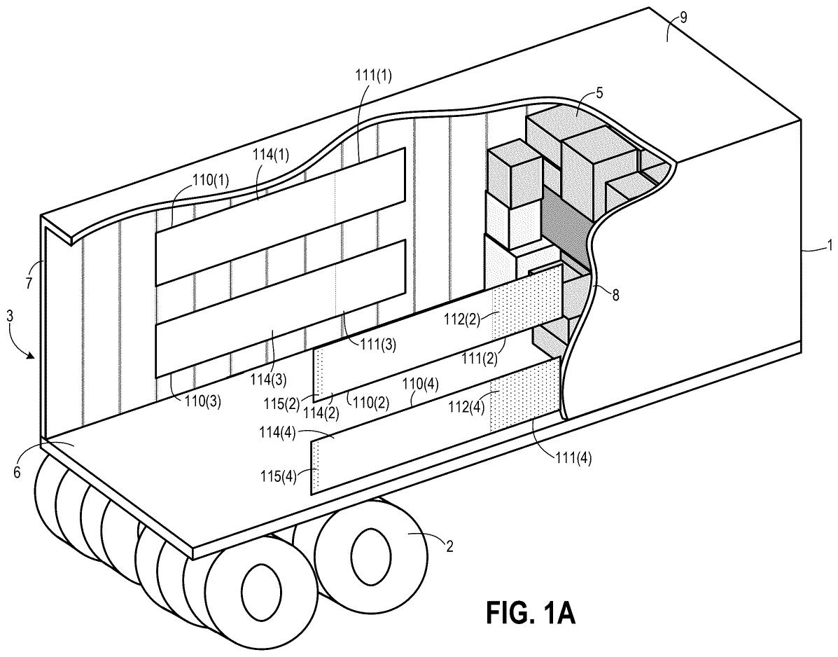

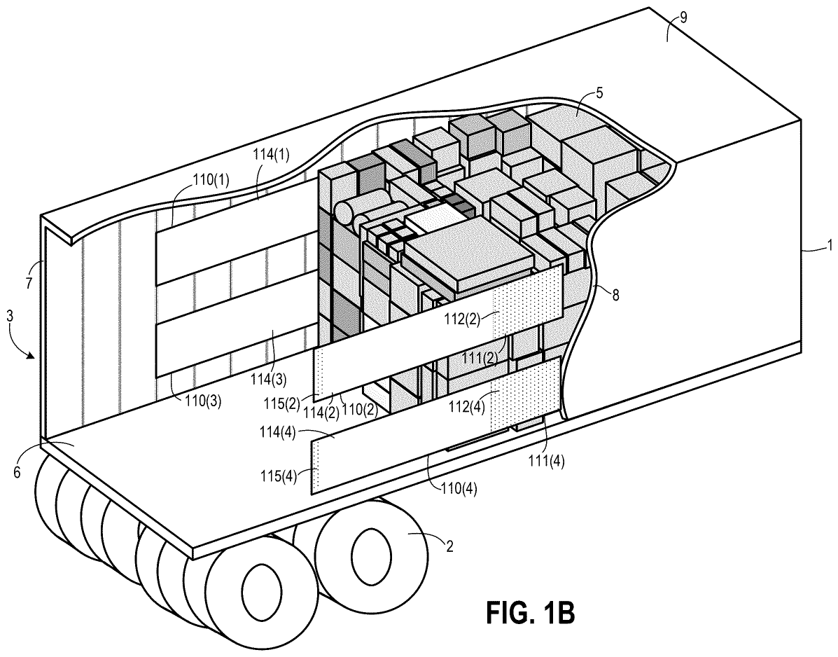

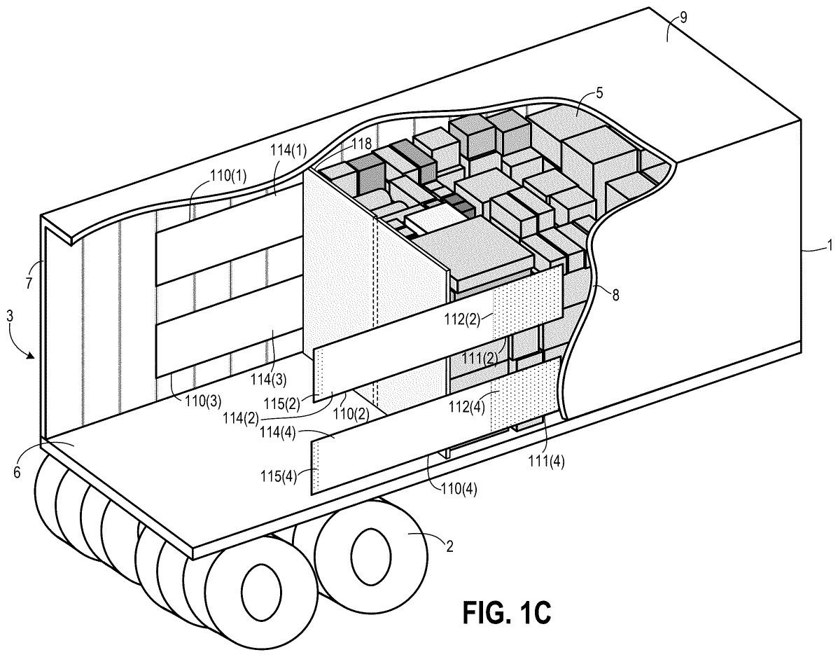

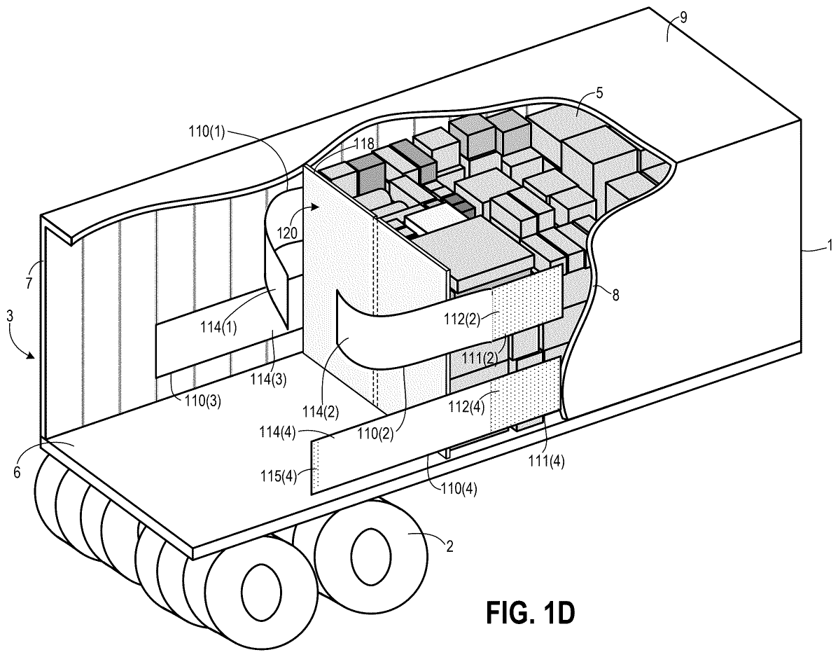

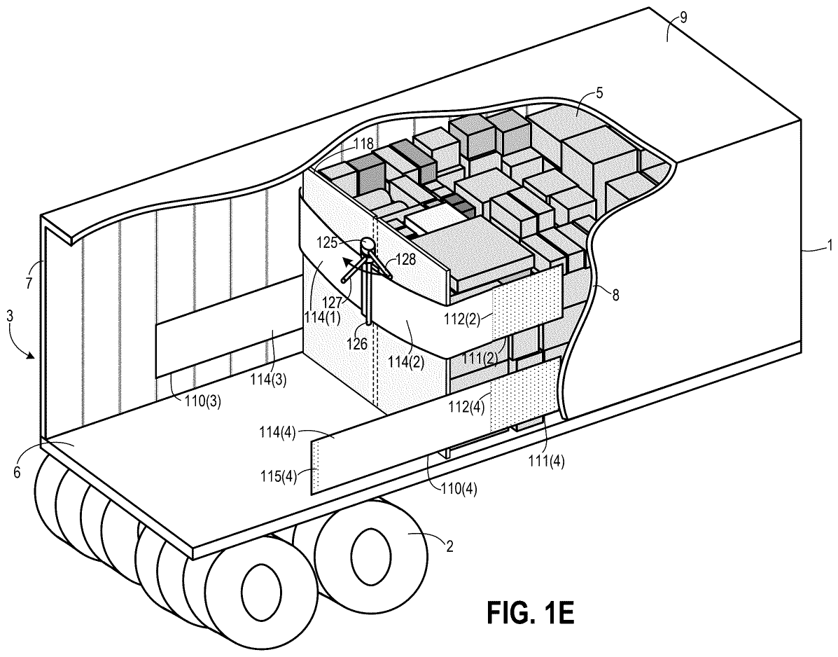

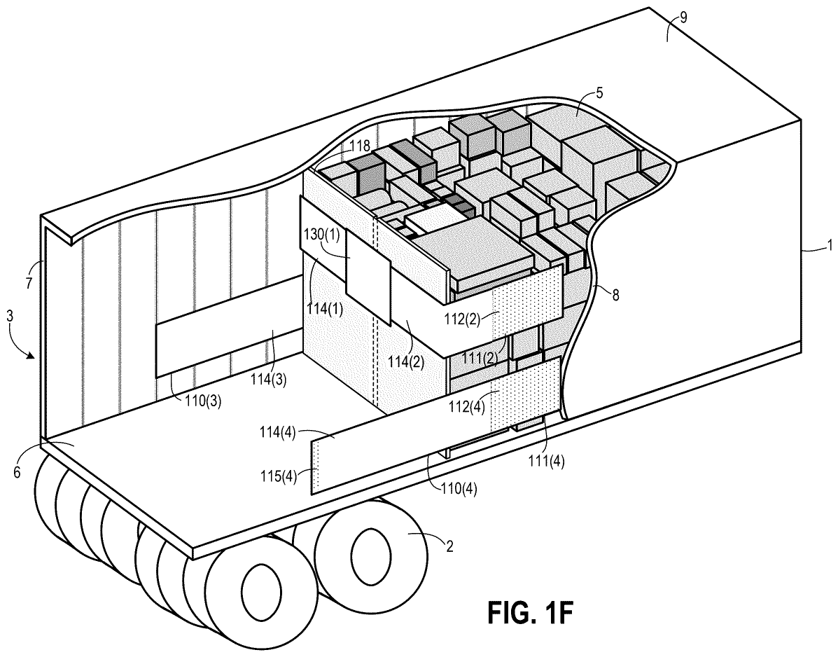

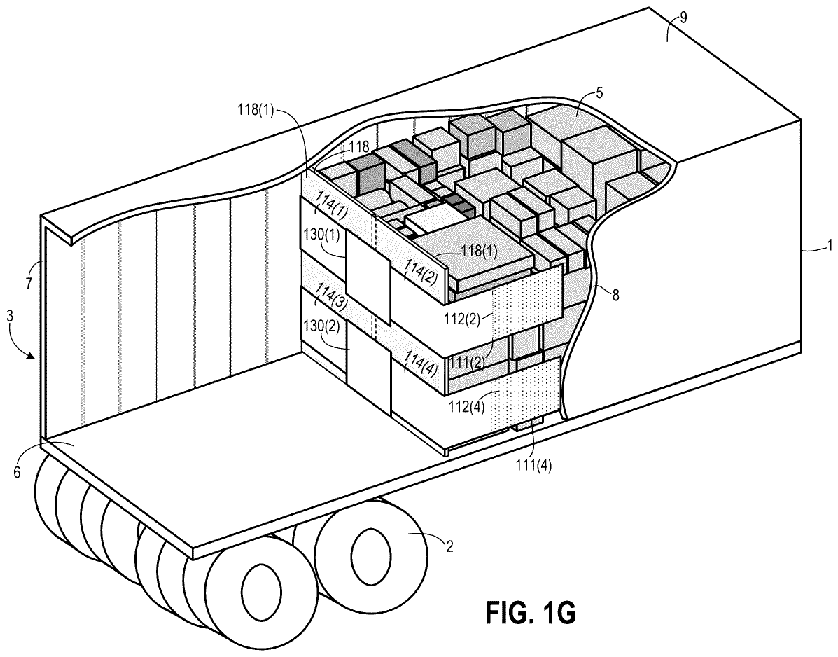

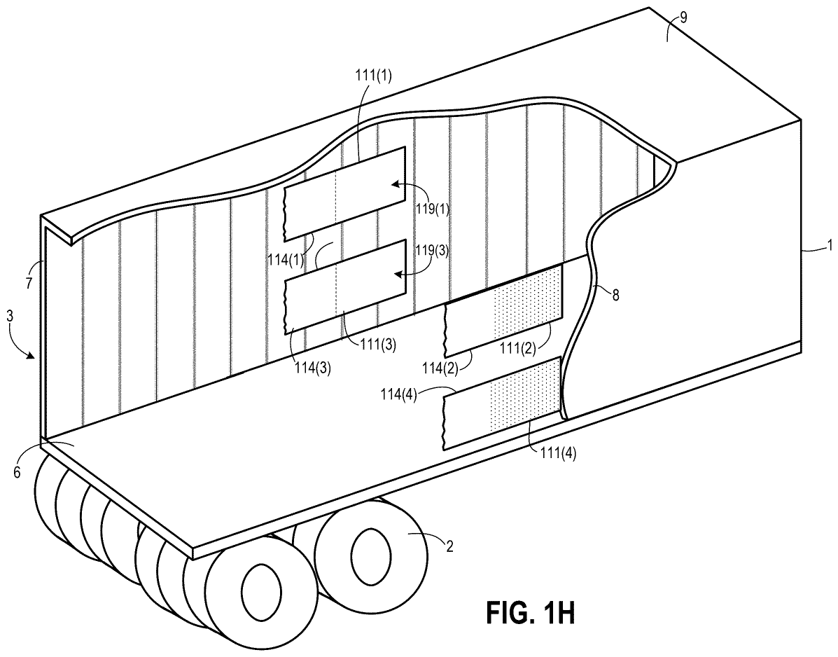

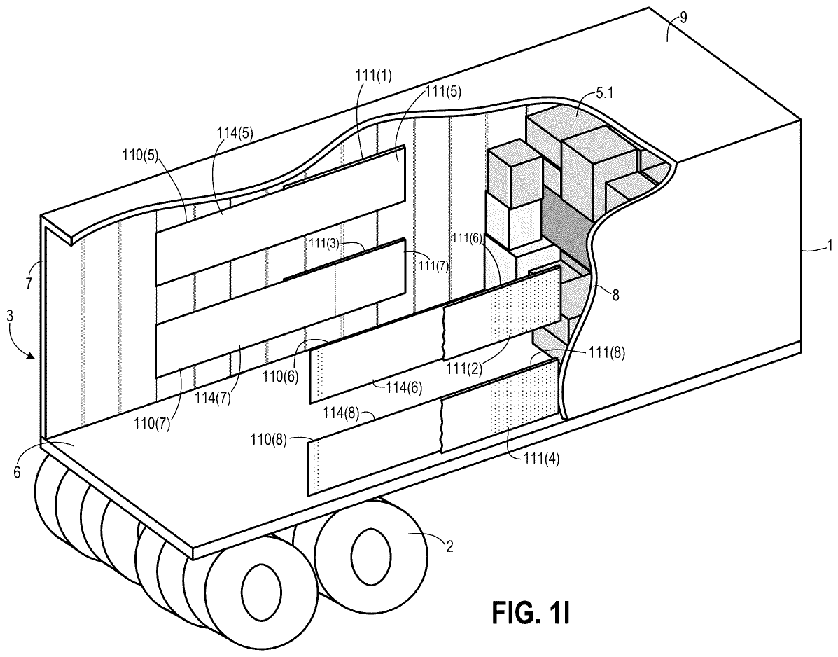

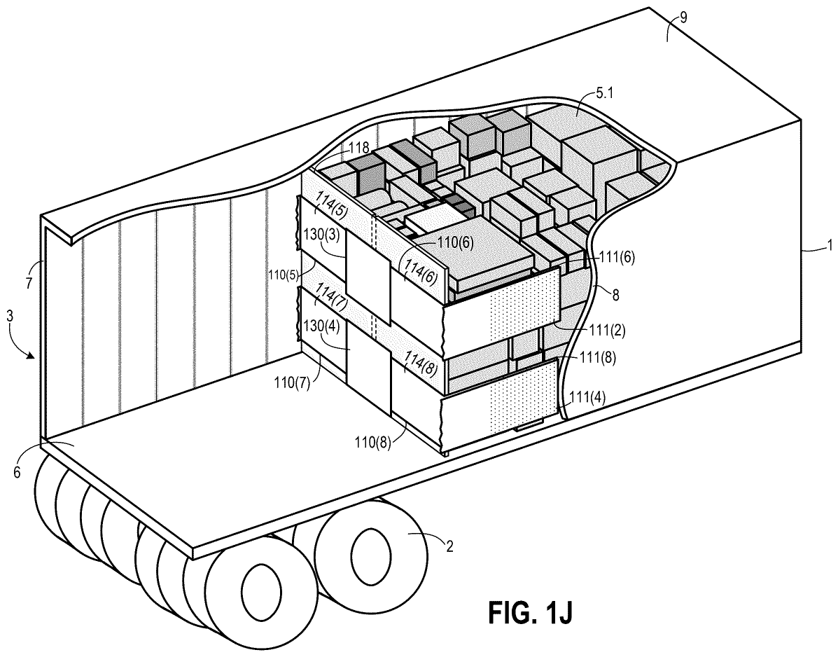

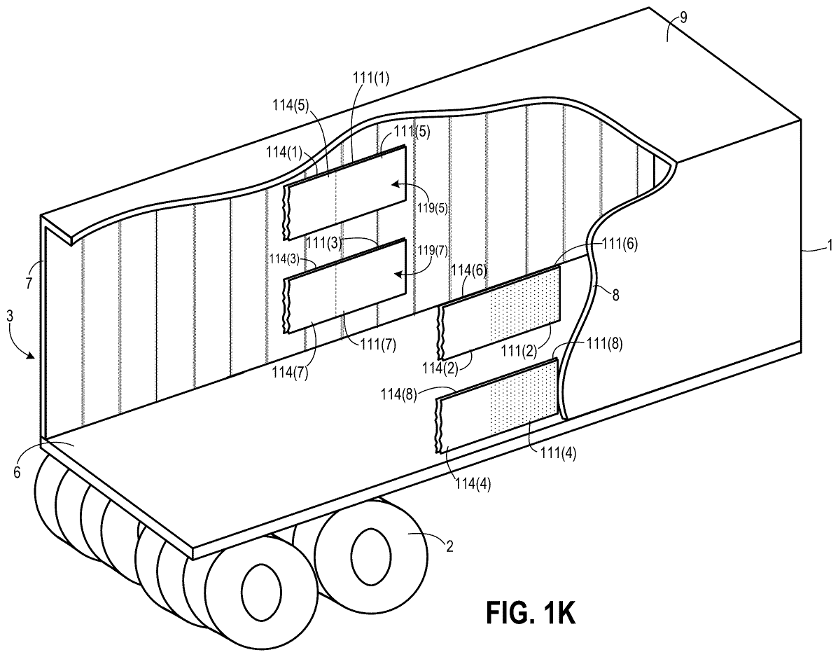

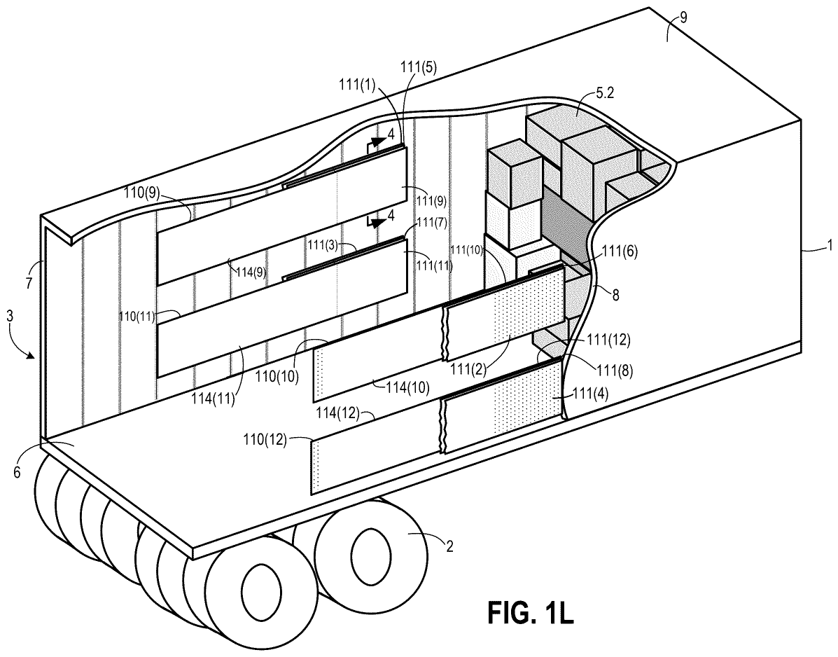

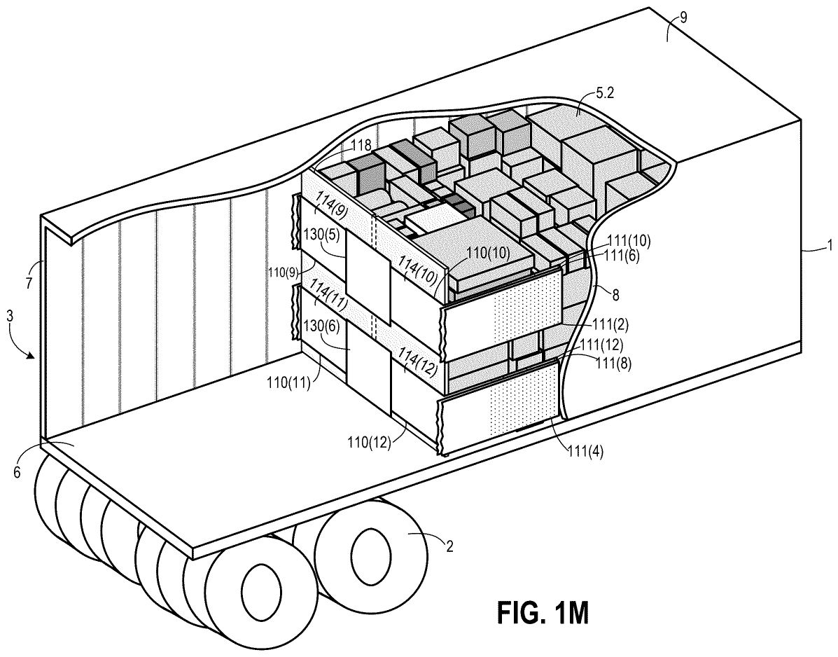

FIGS. 1A through 1M show an example cargo container 1 during various stages of an example method for securing multiple cargo loads using load restraint strips, and in which load restraint strips to secure a subsequent load may be secured to the cargo container 1 by affixation to portions of load restraint strips that secured a previous load. As explained in more detail below, this offers numerous advantages, including reduced time to secure later loads and reduction in waste volume.

FIGS. 1A through 1M show the example cargo container 1. As indicated by wheels 2, the cargo container 1 may comprise a semi trailer. Also or alternatively, methods described herein can be performed using a cargo container that may comprise another type of truck (or portion of another type of truck) used for transportation of cargo via roads, a shipping container, a rail car, or any other type of container used to hold cargo during transport. In each of FIGS. 1A through 1M, a rear end 3 of the cargo container 1 may comprise doors (not shown) used to close the cargo container 1. Portions of a top wall 9 and of a right side wall 8 of the cargo container 1 have been omitted in FIGS. 1A through 1M to reveal interior details.

As shown in FIG. 1A, a front portion of the cargo container 1 has already been loaded with multiple cargo units 5. The cargo units 5 may, for example, comprise boxes, cartons, and/or other types of containers. The cargo units may be a varying sizes, but may be small in size relative in an interior space of the cargo container 1. For example, an average volume of the cargo units 5 may be 3.375 cubic feet (cu. ft.) or less (e.g., 3.5 cu. ft., 3 cu. ft., 2.5 cu. ft., 2 cu. ft., 1.5 cu. ft., 1 cu. ft., etc.) per cargo unit 5. In the example of FIGS. 1A through 1M, the cargo units 5 are not palletized and may be loaded directly onto a floor 6 of the cargo container 1. The cargo units 5 may be stacked directly on one another and may extend from the floor 6 to (or near) an interior surface of a top wall 9 of the cargo container 1, from an interior face of a front wall of the cargo container 1, and from an interior face of a left wall 7 of the cargo container 1 to an interior face of the right wall 8 of the cargo container 1.

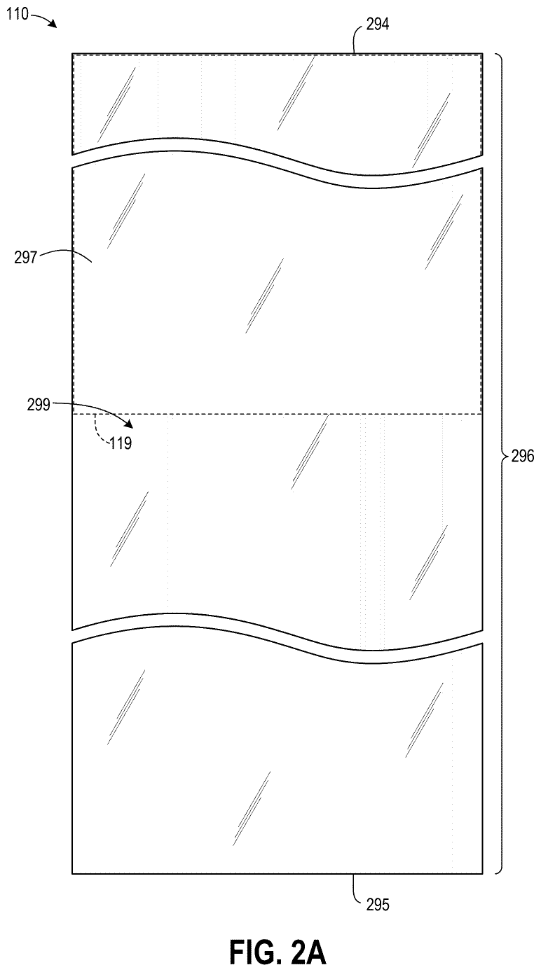

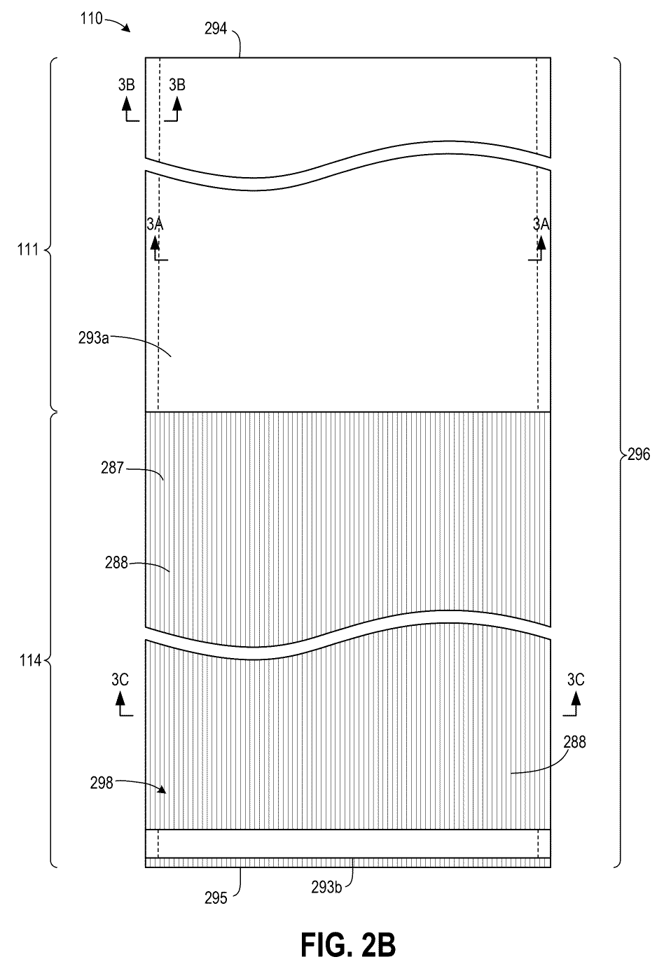

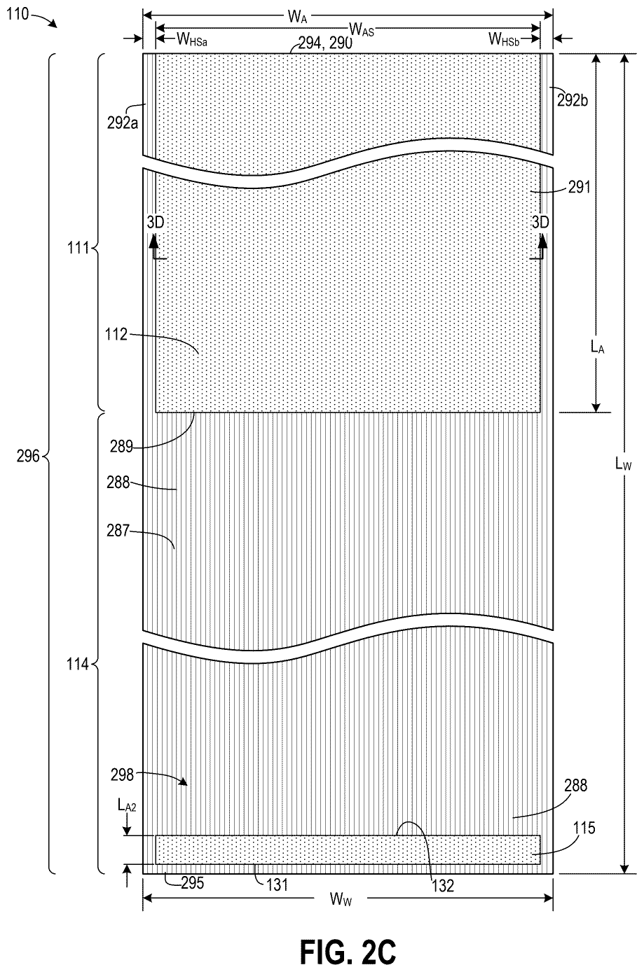

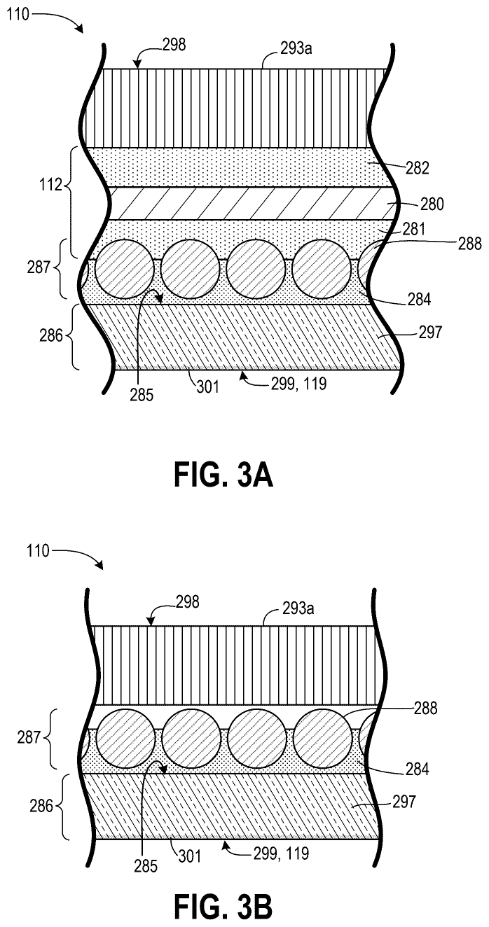

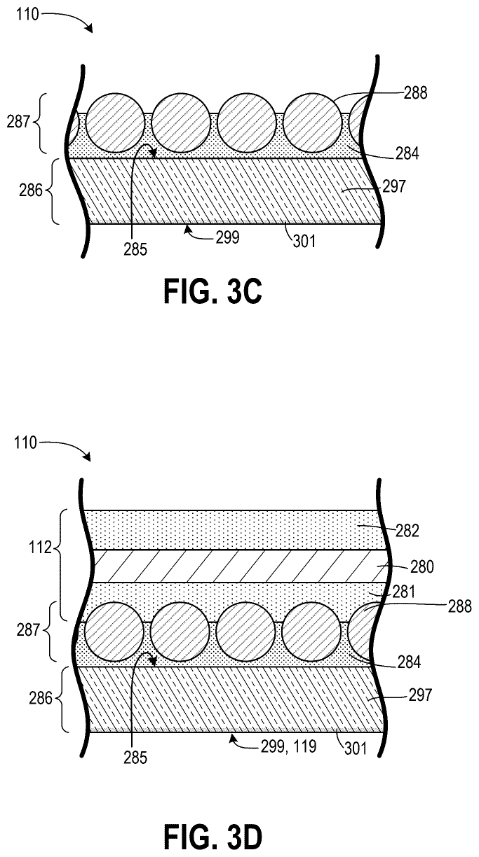

Also shown in FIG. 1A are four load restraint strips 110(1), 110(2), 110(3), and 110(4). The load restraint strips 110(1)-110(4) may all have the structure of the load restraint strip 110 described below in connection with FIGS. 2A through 3D. Each of the load restraint strips 110(1)-110(4) may further comprise an attachment region 111 having an adhesive layer 112, as well as a tail 114.

In FIG. 1A, adhesive (not visible in FIG. 1A) on exterior faces of respective attachment regions 111(1) and 111(3) of the load restraint strips 110(1) and 110(3) is in contact with, and affixed to, the interior face of the left wall 7 of the cargo container 1. Adhesive 112(2) on the exterior face of attachment region 111(2) of the load restraint strip 110(2), as well as adhesive 112(4) on the exterior face of attachment region 111(4) of the load restraint strip 110(4), is in contact with and affixed to the interior face of the right wall 8 of the cargo container 1. A tail 114(2) of the load restraint strip 110(2) extends from the attachment region 111(2) toward the rear 3 of the cargo container 1 and is held in place by an additional adhesive region 115(2) located near the end of the load restraint strip 110(2). A tail 114(4) of the load restraint strip 110(4) extends from the attachment region 111(4) toward the rear 3 of the cargo container 1 and is held in place by an additional adhesive region 115(4) located near the end of the load restraint strip 110(4). Similarly, tails 114(1) and 114(3) of the load restraint strips 110(1) and 110(3) extend from the attachment regions 111(1) and 111(3) toward the rear 3 and are held in place by additional adhesive regions, not shown, similar to the additional adhesive regions 115(2) and 115(4). So that the tails 114(1)-114(4) may be easily pulled away from the interior walls, the additional adhesive regions 115(3) and 115(4) (and similar additional adhesive regions of the tails 114(1) and 114(3)) may be relatively small and/or may comprise an adhesive that has less bonding strength than the adhesive in the attachment regions 111(1) through 111(4). Also or alternatively, the adhesive regions 115 may be omitted and the tails 114 supported by additional pieces of tape.

In FIG. 1B, loading of the cargo units 5 has continued until a rear face of a stack of the cargo units 5 has reached a position in the interior of the cargo container 1 that is past the rear-most portions of the attachment regions 111(1)-111(4). In FIG. 1C, a cargo restraint panel 118 has been placed adjacent to (e.g., against and/or in contact with) the rear face of the stack of cargo units 5. The cargo restraint panel 118 may, for example, comprise a cargo restraint panel described in U.S. patent application Ser. No. 18/533,578, filed Dec. 8, 2023, titled Dual Mode Cargo Restraint, and incorporated by reference herein, and/or one or more cargo restraint panels described in U.S. Patent Application Publication No. 2023/0415632, also incorporated by reference herein. The cargo restraint panel 118 may rest on the floor 6, and may extend above the stack of cargo units 5. Side edges of the cargo restraint panel 118 may be positioned near (or abutting) the interior face of the left wall 7 and the interior face of the right wall 8.

In FIG. 1D, the tails 114(1) and 114(2) of the load restraint strips 110(1) and 110(2) are pulled away from the interior faces of the left wall 7 and the right wall 8 and are wrapped around the cargo restraint panel 118. In particular, the tail 114(1) of the first load restraint strip 110(1) is wrapped around, and brought into contact with, a rear-facing major surface 120 of the cargo restraint panel 118, and the tail 114(2) of the second load restraint strip 110(2) is wrapped around, and brought into contact with, the major surface 120.

In FIG. 1E, a tightening tool 125 is placed over the tails 114(1) and 114(2). The tool 125 includes a pair of tines 126 that define a slot. Only one of the tines 126 is visible in FIG. 1E. The tines 126 of the tool 125 may be slid over the overlapped ends of the tails 114(1) and 114(2) so as to hold those overlapped ends in the slot between the tines 126. After placement of the tool 125, a handle 127 is held stationary and a handle 128 is rotated in the direction indicated. This rotates the tines 126 and draws the tails 114(1) and 114(2) together, thereby tensioning the tails 114(1) and 114(2) to apply force against the cargo restraint panel 118 and push the cargo restraint panel 118 against the stack of cargo units 5. The ends of the tails 114(1) and 114(2) may then be secured together by applying an adhesive backed connecting patch 130(1) over those ends, and the tool 125 removed, as shown in FIG. 1F. The connecting patch 130(1) may, for example, comprise a patch of material such as that sold under the name Ty-Patch 2000@ by Walnut Industries, Inc. of Bensalem, PA, US. The connecting patch 130(1) may, for example, comprise a backing material, similar to that of the load restraint strips 110(1)-110(4), with reinforcing strands similar to those of the load restraint strips 110(1)-110(4). An adhesive layer that contacts the tails 114(1) and 114(2) may comprise an adhesive that is similar to that of the adhesive layers 112(2) and 114(4), or may comprise a different type of adhesive (e.g., a rubber cement selected to bond to surfaces the tails 114(1) and 114(2)).

The tails 114(3) and 114(4) of the load restraint strips 110(3) and 110(4) may, in a manner similar to that shown in FIGS. 1D and 1E, be wrapped around the cargo restraint panel 118 and tightened using the tool 125. A connecting patch 130(2) may be applied, in a manner similar to that described for the connecting patch 130(1), to the tightened tails 114(3) and 114(4), and the tool 125 removed, as shown in FIG. 1G. In the configuration shown in FIG. 1G, the load restraint strips 110(1)-110(4) and the cargo restraint panel 118 provide dual mode securement of the cargo units 5. The cargo restraint panel 118 is securely held in position against the stack of cargo units 5 by the load restraint strips 110(1)-110(4), but without need of special hardware or attachment mechanisms to connect the cargo restraint panel 118 the walls, floor, or ceiling of the cargo container 1. The cargo restraint panel 118, while held against the cargo units 5 stack by the load restraint strips 110(1)-110(4), acts as a secure bulkhead to prevent shifting of the cargo units 5 during acceleration of the cargo container 1.

FIG. 1H shows the cargo container 1 after unloading of the cargo units 5 (e.g., after the cargo container 1 has reached its destination). To access and unload the cargo units 5, the load restraint strips 110(1)-110(4) were severed by cutting (e.g., with a knife or scissors) portions of the load restraint strips 110(1)-110(4) between the side edges of cargo restraint panel 118 and the interior faces of the walls 7 and 8. The cargo restraint panel 118, which may be reused, was then removed. As shown in FIG. 1H, previously-affixed attachment regions 111(1) and 111(3) remain attached to the interior face of the left wall 7 and previously-affixed attachment regions 111(2) and 111(4) remain attached to the interior face of the right wall 8. Respective interior faces 119(1) and 119(3) of attachment regions 111(1) and 111(3) are exposed, as are similar interior faces of attachment regions 111(2) and 111(4). Segments of the tails 114(1) through 114(4) may also remain.

In FIG. 1I, load restraint strip 110(5) has been secured, via the previously-affixed attachment region 111(1), to the interior face of the left wall 7. In particular, adhesive on an exterior face of the attachment region 111(5) was affixed to the interior face 119(1) of the previously-affixed attachment region 111(1). Load restraint strip 110(7) has been secured, via the previously-affixed attachment region 111(3), to the interior face of the left wall 7 by affixing adhesive on the exterior face of the attachment region 111(7) to the interior face 119(3) of the previously-affixed attachment region 111(3). Load restraint strip 110(6) has been secured, via the previously-affixed attachment region 111(2), to the interior face of the right wall 8 by affixing adhesive on the exterior face of the attachment region 111(6) to the interior face of the previously-affixed attachment region 111(2). Load restraint strip 110(8) has been secured, via the previously-affixed attachment region 111(4), to the interior face of the right wall 8 by affixing adhesive on the exterior face of the attachment region 111(8) to the interior face of the previously-affixed attachment region 111(4).

After loading additional cargo units 5.1, steps similar to those described in connection with FIGS. 1C through 1G may be performed. The cargo restraint panel 118 (or another cargo restraint panel) may be placed adjacent to (e.g., against and/or in contact with) the rear face of the stack of cargo units 5.1. The tails 114(5) and 114(6) of the load restraint strips 110(5) and 110(6) may be pulled away from the interior faces of the left wall 7 and the right wall 8, wrapped around the cargo restraint panel 118, tightened with the tightening tool 125, and secured with a patch 130(3). The tails 114(7) and 114(8) of the load restraint strips 110(7) and 110(8) may be pulled away from the interior faces of the left wall 7 and the right wall 8, wrapped around the cargo restraint panel 118, tightened with the tightening tool 125, and secured with a patch 130(4). FIG. 1J shows the cargo container 1 after performance of thee additional steps.

FIG. 1K shows the cargo container 1 after the cargo units 5.1 have been unloaded. To access and unload the cargo units 5.1, the load restraint strips 110(5)-110(8) were severed by cutting (e.g., with a knife or scissors) portions of the load restraint strips 110(5)-110(8) between the side edges of cargo restraint panel 118 and the interior faces of the walls 7 and 8. The cargo restraint panel 118, which may be reused, was then removed. As shown in FIG. 1K, previously-affixed attachment regions 111(5) and 111(7) remain secured, via previously-affixed attachment regions 111(1) and 111(3), to the interior face of the left wall 7 and previously-affixed attachment regions 111(6) and 111(8) remain secured, via previously-affixed attachment regions 111(2) and 111(4), to the interior face of the right wall 8. Respective interior faces 119(5) and 119(7) of attachment regions 111(5) and 111(7) are exposed, as are similar interior faces of attachment regions 111(6) and 111(8). Segments of the tails 114(5)-114(8) may also remain.

In FIG. 1L, load restraint strip 110(9) has been secured, via the previously-affixed attachment regions 111(1) and 111(5), to the interior face of the left wall 7. In particular, adhesive on the exterior face of the attachment region 111(9) was affixed to the interior face 119(5) of the previously-affixed attachment region 111(5). Load restraint strip 110(11) has been secured, via the previously-affixed attachment regions 111(3) and 111(7), to the interior face of the left wall 7 by affixing adhesive on the exterior face of the attachment region 111(11) to the interior face 119(7) of the previously-affixed attachment region 111(7). Load restraint strip 110(10) has been secured, via the previously-affixed attachment regions 111(2) and 111(6), to the interior face of the right wall 8 by affixing adhesive on the exterior face of the attachment region 111(10) to the interior face of the previously-affixed attachment region 111(6). Load restraint strip 110(12) has been secured, via the previously-affixed attachment regions 111(4) and 111(8), to the interior face of the right wall 8 by affixing adhesive on the exterior face of the attachment region 111(12) to the interior face of the previously-affixed attachment region 111(8).

After loading additional cargo units 5.2, steps similar to those described in connection with FIGS. 1C through 1G may be performed. The cargo restraint panel 118 (or another cargo restraint panel) may be placed adjacent to (e.g., against and/or in contact with) the rear face of the stack of cargo units 5.2. The tails 114(9) and 114(10) of the load restraint strips 110(9) and 110(10) may be pulled away from the interior faces of the left wall 7 and the right wall 8, wrapped around the cargo restraint panel 118, tightened with the tightening tool 125, and secured with a patch 130(5). The tails 114(11) and 114(12) of the load restraint strips 110(11) and 110(12) may be pulled away from the interior faces of the left wall 7 and the right wall 8, wrapped around the cargo restraint panel 118, tightened with the tightening tool 125, and secured with a patch 130(6). FIG. 1M shows the cargo container 1 after performance of these additional steps.

Subsequently, the cargo units 5.2 may be accessed and unloaded by severing (e.g., cutting with a knife or scissors) portions of the load restraint strips 110(9)-110(12) between the side edges of cargo restraint panel 118 and the interior faces of the walls 7 and 8 and by removing (or simply moving) the cargo restraint panel 118. Additional cargo may be loaded. New load restraint strips may be secured, via previously-affixed attachment regions, to the interior faces of the walls 7 and 8 by affixing adhesive on exterior faces of attachment regions of the new load restraint strips to the interior faces of innermost previously-affixed attachment regions. Additional cargo may be loaded, the cargo restraint panel 118 put in place, and tails of the new load restraint strips may be tightened and secured with adhesive patches. This sequence of steps may be repeated numerous times (e.g., 5, 10, 15, or more times).

Depending on the type of cargo being secured, a cargo restraint panel may be optional. For example, for large and/or palletized cargo units, a cargo restraint panel may be omitted. In some variations of the above method, only one pair of load restraint strips may be used to secure some or all cargo loads. For example, a load may be secured with a single pair of load restraint strips that are wider than those shown in FIGS. 1A through 1M.

Methods, such as those described in connection with FIGS. 1A through 1M, in which load restraint strips to secure a subsequent load may be secured to a cargo container by affixation to portions of load restraint strips that secured a previous load, offer numerous advantages. In some scenarios (e.g., when cargo is transported by truck over relatively short distances and/or where a truck is quickly reloaded after unloading), new load restraint strips may be installed at relatively frequent intervals. In such scenarios, small amounts of time saved by not removing pre-affixed load restraint strip attachment regions can accumulate and result in significant time and cost savings, particularly where a large fleet of trucks or other cargo containers is involved.

Moreover, successively installing load restraint strips onto pre-affixed portions of other load restraint strips may reduce volumes for purposes of waste disposal. Although attachment regions of numerous load restraint strips may be successively applied in the same location (e.g., attachment regions 111(1), 111(5), and 111(9) of FIG. 1L), at some point it may be necessary to remove those attachment regions. But because those attachment regions are inter-bonded (e.g., adhered to one another) and may be removable from a cargo container wall as a single sheet, they may consume less volume as waste than would be the case if those attachment regions were separate sheets.

After load restraint strip attachment regions are removed from a cargo container wall, they are normally disposed of as ordinary trash. Although trash volume of removed attachment regions could be minimized by carefully folding those removed attachment regions and/or by collecting the removed attachment regions and carefully stacking the collected attachment regions in flattened form, expecting such practices ignores the realities of many shipping environments. For example, there is often significant time pressure to quickly unload and reload a cargo container, and workers may have little time to spend dealing with trash disposal. Attempting to neatly fold or stack individual removed attachment regions, which may have curls imparted during the removal process and/or residual adhesive that make handling difficult, would be time consuming and frustrating. As a result, removed attachment regions are typically “wadded up” (e.g., crumpled, crushed, and/or compressed) into a wad and thrown into the trash or on the ground. Similar to wads of paper or other material, much of the volume of a removed attachment region wad is occupied by air pockets created by random structures formed as the removed attachment region is wadded.

And similar to how wadding a stack of multiple sheets of paper usually results in a wad that occupies less total volume than a collection of wads resulting from wadding each of those sheets individually, wadding a stack of removed attachment regions may result in a wad that consumes less total volume than a collection of wads that would result from wadding each of the removed attachment regions individually. By affixing attachment regions of load restraint strips for a new load onto previously-affixed attachment regions of load restraint strips for the previous load, and by repeating this for additional loads, stacks of load restraint strips are automatically created as part of the loading process, and without adding any additional time to the normal loading process. When such a stack is ultimately removed, it may be formed into a wad that occupies less total volume than would have been occupied by a collection of wads created from individual attachment regions in that removed stack. And in some circumstances, these stacks created by applying new load restraint strip attachment regions to old load restraint strip attachment regions may promote additional waste volume reduction. For example, if a stack of removed attachment regions contains a sufficient number of attachment regions, the stack may be relatively stiff and resistant to wadding, but may also be easier to handle (e.g., because of less imparted curl). In such a case, it may actually be easier and/or more cost efficient for workers to collect these stacks into piles of flattened stacks (which would consume even less volume) for disposal.

FIG. 2A is a partially schematic plan view showing an interior face 299 of an example load restraint strip 110 that is configured to facilitate methods, such as those described herein, for securing multiple cargo loads using load restraint strips, and in which load restraint strips to secure a subsequent load may be secured to a cargo container by affixation to portions of load restraint strips that secured a previous load. In particular, and unlike load restraint strips having a backing with a surface (e.g., a fabric or spunbonded mat) that is rough and/or porous, the load restraint strip 110 has a backing with a smooth polymer surface that improves adhesion by the adhesive in attachment regions of other load restraint strips. The load restraint strips 110(1)-110(12) of FIGS. 1A through 1M have the structure of the example load restraint strip 110. In other examples of the methods described herein, however, some or all load restraint strips may have different structures.

FIG. 2B is a partially schematic plan view showing an exterior face 298 of the load restraint strip 110. An exterior face of a load restraint strip is the face that includes the adhesive that contacts a container wall (or previously-affixed load restraint strip attachment region) when the load restraint strip is attached to that wall (or previously-affixed load restraint strip attachment region). In general, and except for portions in an end of the load restraint strip that is wound with the end of another load restraint strip during tightening, the exterior face of a load restraint strip faces away from cargo when the load restraint strip is installed. An exterior face or side of an element of a load restraint strip is a side or face of that element that, when the load restraint strip is laid flat (as in FIGS. 2A through 2C), faces the same direction as the adhesive. An interior face of a load restraint strip is the face opposite the exterior face and that, except for portions in an end of the load restraint strip that is wound with the end of another load restraint strip during tightening, generally faces toward cargo when the strip is installed. An interior face or side of an element of a load restraint strip is a side or face of that element that, when the load restraint strip is laid flat, faces the same direction as the load restraint strip interior face. The interior face 299 comprises an interior face 119 of an attachment region 111, the approximate boundary of which is shown in broken line in FIG. 2A, that is opposite a portion of the exterior face 298 that corresponds to the attachment region 111.

Wave shaped notations are added to FIGS. 2A through 2C to schematically indicate portions of the load restraint strip 110 that have been omitted from the figures for convenience, but that are present in an actual load restraint strip. The notations do not represent actual interruptions in the structure of the load restraint strip 110. Instead, each of the notations represents a portion of the load restraint strip 110 that extends continuously and unbroken over an arbitrary length and that has structure identical to structure in the regions immediately adjacent to the notation. A similar convention applies to wave-shaped notations in other drawing figures. Also visible in FIG. 2A is a band 297 of polymer material that forms a base layer of the load restraint strip 110. The load restraint strip 110 has a working portion 296. In the example of the load restraint strip 110, working portion 296 extends the entire length of the load restraint strip 110 from a first strip end 295 to a second strip end 294. However, a working portion of a load restraint strip may be less than the entire length of that load restraint strip. Multiple load restraint strips 110 may be joined together and wound on a roll. Lines and/or perforations in a widthwise direction may separate ends 294 and 295 of adjacent load restraint strips 110 on that roll. The load restraint strips 110 can be removed from the roll by tearing and/or cutting along the lines and/or perforations.

FIG. 2B shows the exterior face 298 of the load restraint strip 110 in a lined configuration. In particular, and as explained in further detail below, a release paper liner 293a is attached to cover an adhesive layer in an attachment region 111 and a release paper liner 293b is attached to cover another adhesive region used to temporarily support a tail 114 during installation of the load restraint strip 110. FIG. 2C is another partially schematic plan view showing the exterior face 298 of the load restraint strip 110, but with the release paper liner 293a removed to expose an adhesive layer 112 and the release paper liner 293b removed to expose an adhesive layer 115. Once exposed by removal of the liner 293a, the adhesive layer 112 can be pressed against an interior face of a wall of a cargo container, or to an exposed attachment region interior face 119 of a previously-affixed attachment region 111 of a previously used load restraint strip 110, so as to secure the attachment region 111 of the load restraint strip 110 to that container wall inner face. A tail 114 of the load restraint strip 110 can then extend away from attachment region 111. That tail 114 may, after securing of the attachment region 111, initially extend along the container wall and be supported by the adhesive 115. As described above, a tail 114 may subsequently be wrapped around cargo (and around a cargo restraint panel, if used) and then tightened with, and secured to, a tail of another load restraint strip. The broken lines extending lengthwise in the attachment region 111 in FIG. 2B indicate edges of the adhesive layer 112 in the attachment region 111, as well as edges of handling subregions 292a and 292b shown in FIG. 2C. The broken lines shown extending lengthwise on the liner 293b similarly indicate edges of the adhesive 115, as well as edges of handling subregions similar to subregions 292a and 292b.

In the example of the load restraint strip 110, the adhesive layer 112 extends throughout an adhesive subregion 291 of the attachment region 111. The adhesive subregion 291 has a width W_{AS}. The handling subregions 292a and 292b have respective widths W_{HSa} and W_{HSb} and extend from edges of the adhesive subregion 291 to side edges of the load restraint strip 110. An end 290 of the adhesive layer 112, the attachment subregion 291, and the attachment region 111 is aligned with the end 294 of the load restraint strip 110 and of the working portion 296. Alternatively, the end 290 of the adhesive layer 112 may be near (e.g., within 3 inches) of the end 294 of the load restraint strip 110. An end 289 of the adhesive layer 112, the attachment subregion 291, and the attachment region 111 is located at an intermediate location between the end 294 and the end 295 of the load restraint strip 110 and of the working portion 296. As indicated in FIG. 2C, the working portion 296 has a length L_{W} and a width W_{W}. The attachment region 111 has a length L_{A} and width W_{A}, and W_{A} may equal W_{W}. The handling subregions 292a and 292b may be sub-regions of the attachment region 111 in which the adhesive of the adhesive layer 112 has been omitted, and which may provide convenient regions for a worker to grip the attachment region during installation of the load restraint strip 110. Widths W_{HSa} and W_{HSb} of the handling subregions 292 may, for example, be between 1 and 2 inches. The length L_{W} may, for example, be between 9 and 14 feet (e.g., 12 feet). The length L_{A} may, for example, be between 2 and 6 feet (e.g., 5 feet). The width W_{W} may, for example, be between 10 and 50 inches (e.g., 16 inches, 32 inches, 36 inches, or 40 inches). Optionally, W_{A} may be less than W_{W}, and/or the handling subregions 292 may be omitted (e.g., the adhesive of the adhesive region 112 may extend to side edges of the attachment region 111).

As seen in FIGS. 2B and 2C, and as discussed more fully below, the load restraint strip 110 includes a plurality of reinforcing strands 288 in a reinforcement layer 287. The strands 288 are indicated as black lines on exterior face 298. To avoid obscuring FIGS. 2B and 2C with unnecessary detail, the number of black lines is significantly less than the number of reinforcing strands that may be present in an actual load restraint strip 110. Moreover, the strands 288 could be white, off-white, or otherwise lightly colored, translucent, or transparent. In the example of the load restraint strip 110, and as shown in FIGS. 2B and 2C, the reinforcement strands 288 only extend in a direction parallel to the length L_{W} of the load restraint strip 110.

The adhesive 115, which may comprise an adhesive similar to that of the adhesive layer 112, may have a length L_{A2} (e.g., 1 to 12 inches). An edge 131 of the adhesive 115 may be aligned with, or be near (e.g., within 12 inches) the end 295 of the load restraint strip 110. An edge 132 of the adhesive 115 may be separated from the edge 289 of the adhesive region 112 by a region of the exterior face 298 in which active adhesive is absent. An active adhesive may comprise an adhesive that is uncured, has not set, and/or that is not pressure-sensitive (e.g., would not adhere to support the load restraint strip 110 if pressed into contact with a container wall or other vertical surface). Conversely, an adhesive that has set, been cured, and/or is not pressure-sensitive may be inactive, even if that adhesive is still forming a bond (e.g., a bond between reinforcing strands and 288 and the band 287).

FIG. 3A is a partially schematic, truncated cross-sectional view of the load restraint strip 110 taken from the location indicated in FIG. 2B. FIG. 3A shows elements of the attachment region 111 when the load restraint strip 110 is in a lined configuration, i.e., with release paper liner 293a in place. The bold, curved truncation lines at the sides of FIG. 3A indicate that the structure shown in FIG. 3A extends throughout the adhesive subregion 291 of the attachment region 111.

In addition to adhesive layer 112 and reinforcement layer 287, the load restraint strip 110 includes a base layer 286. The reinforcement layer 287 and the base layer 286 extend throughout the entire length of working portion 296 of the load restraint strip 110, whereas attachment layer 112 is confined to attachment region 111. The base layer 286 may comprise the band 297 of polymer material. The band 297 may be nonporous. The band 297 may comprise a homogenous single sheet of polymer material or may comprise multiple sheets (of the same or different materials) that have been bonded to one another. Example materials for the band 297, which may be selected to improve adherence of the adhesive of adhesive layer 112, may include, without limitation, polyethylene (PE), polyethylene terephthalate (PET), biaxially-oriented polypropylene (BOPP), polypropylene (PP), high density polyethylene (HDPE), medium density polyethylene (MDPE), low density polyethylene (LDPE), and/or other materials. The polymer material of the band 297 may be transparent, translucent, or opaque. The polymer material of the band 297 may be tinted or untinted. Example properties of polymers that may be used for the polymer material of the band 297 comprise elasticity less than 40%, tensile strength of up to 100 psi (pounds per square inch), and a basis weight of less than 50 gsm. However, load restraint strips may comprise base layer bands formed from polymers with one or more of these properties having a value significantly outside one of the aforementioned ranges.

The interior face 119 of the attachment region 111, or the entire interior face 299 of the load restraint strip 110, may comprise a surface treatment 301 to promote adhesion of the first adhesive sublayer 282 (discussed below) of the adhesive layer 112. The surface treatment 301, which is shown in FIG. 3A and in subsequent FIGS. as a gray band, may be any of various structures formed in various ways. The surface treatment 301 may comprise an adhesion promoter compound that has been applied to a surface of the band 297. Such an adhesion promoter may, for example, comprise a urethane cross-linked acrylic primer. Also or alternatively, the surface treatment may comprise a surface that has had its structure altered by corona treatment or by plasma treatment. The surface treatment 301 may, for example, increase the surface energy or dyne value of the interior face 119 of the attachment region 111 or of the entire interior face 299 of the load restraint strip 110.

The surface treatment 301 is optional. In some examples of the methods described herein, some or all load restraint strips may have attachment region interior faces (and/or entire interior faces) without the surface treatment 301.

The reinforcement layer 287 is fixed relative to the base layer 286. In particular, the reinforcement strands 288 are bonded to an exterior face 285 of the band 297 by a laminating adhesive 284. The strands 288 may be parallel to one another and to the length L_{W} direction of working portion 296, and the load restraint strip 110 may omit reinforcement strands oriented in other directions. Each of the strands 288 may, for example, comprise one or more polymer fibers and have a denier (i.e., a linear mass density in grams per 9000 meters) of between about 1400 and about 1650. For example, the strands 288 may have a denier between about 1450 and about 1600 (e.g., between about 1479 and about 1547, with target denier of about 1513). The reinforcement layer may comprise between about 100 reinforcing strands 288 and about 320 reinforcing strands 288 in a load restraint strip having a width W_{W} of 16 inches, resulting in a strand distribution density (in a direction across width W_{W} and perpendicular to length Lw) of between 6.25 and 20 strands per inch. A load restraint strip (regardless of width W_{W}) may, for example, have a strand distribution density (in a direction across width W_{W} and perpendicular to length Lw) of between 5 and 25 strands per inch. Example materials for the strands 288 comprise polyester. Table 1 shows example properties for polyester strands that may be used for reinforcing strands 288.

TABLE 1
Example Polyester Strand Properties

| | Target | Min. | Max. |
|---|---|---|---|
| Property | Value | Value | Value |
| liner density (denier, i.e. g/9000 m) | 1513 | 1479 | 1547 |
| break load (pounds) | 26.6 | 24.6 | 28.7 |
| elongation at break (%) | 10.3 | 8.8 | 11.8 |
| elongation at 10 lb. load (%) | 3.4 | 2.9 | 3.9 |
| shrinkage, free (%) | 8.4 | 4.8 | 12.0 |

The ranges in Table 1 are solely for purposes of example. Load restraint strips may comprise reinforcing strands having one or more properties significantly outside a range indicated in Table 1. A reinforcement layer of a load restraint strip may also or alternatively comprise reinforcement strands formed from glass, polypropylene, carbon, or some other material. The reinforcing layer 287 may have tensile strength, in a direction parallel to length Lw, that is greater than a tensile strength of the base layer 286.

The laminating adhesive 284 may comprise a transparent ethylene vinyl acetate water-based copolymer adhesive having a viscosity between about 2900 centipoise (cps) and about 3200 cps. However, load restraint strips may comprise a laminating adhesive having a viscosity significantly outside this range and/or that comprises a different type of adhesive. As indicated above, adhesive 284 is used to bond the reinforcing strands 288 to the exterior face 285 of the band 297.

The adhesive layer 112 is fixed relative to reinforcement layer 287, and relative to the base layer 286. Unlike the reinforcement layer 287 and the base layer 286, however, and as seen in FIG. 2C, the adhesive layer 112 is confined to attachment region 111. The adhesive layer 112 may, for example, comprise the first adhesive sublayer 282, a second adhesive sublayer 281 and a substrate sublayer 280. The substrate sublayer 280 at least partially separates the adhesive sublayers 282 and 281. The substrate 280 may include holes or other perforations permitting direct contact between the adhesive sublayers 282 and 281 in certain areas. The substrate 280 may optionally be omitted. The release paper liner 293a is affixed to the exterior side of the adhesive sublayer 282 when the load restraint strip 110 is in a lined configuration. The liner 293a may, for example, be formed from a paper product that is treated (e.g., coated or otherwise impregnated with wax, silicone or other non-stick material) to resist the adhesive of the sublayer 282.

The adhesive sublayers 282 and 281 may contain the same type of adhesive. For example, the adhesive sublayers 282 and 281 contain an acrylic adhesive having a shear strength of between about 50 psi and about 100 psi. The adhesive layer 112 may, for example, have a thickness of approximately 3 mils (with 1 mil=. 001 inch). However, a load restraint strip having one or more features described herein may alternatively have an adhesive layer adhesive with properties significantly outside that shear strength range and/or having a substantially different thickness.

The substrate sublayer 280 may comprise a film of PET or other polymer and may have a thickness of between about 0.5 mils and about 1.0 mils. If a substrate sublayer is present, it may make little or no contribution to the load restraining strength of a load restraint strip and may simply serve as a carrier for adhesive sublayers 282 and 281. In particular, the adhesive layer 112 may initially take the form of a double-sided adhesive tape having the substrate sublayer 280 sandwiched by the adhesive sublayers 281 and 282. The release paper liner 293a may be attached to one side of that tape. A portion of that double-sided tape may be cut from a larger roll and applied to a portion of a partially-completed load restraint strip during a manufacturing process. As indicated above, a substrate sublayer may be omitted. If a substrate sublayer is omitted, a layer of acrylic adhesive substantially similar to the sublayer 282 may be applied to a partially-completed load restraint strip using transfer tape or other process (e.g., direct application via spraying and/or distributed using a spreader blade and/or partially cured after application/spreading).

Alternatively, the sublayers 282 and 281 may comprise different types of adhesives. The adhesive sublayer 282 is adhered to a cargo container wall, or to an exposed interior face 119 of a previously-affixed load restraint strip, when the load restraint strip 110 is installed. Many applications require that the adhesive bond the between the sublayer 282 and a container wall be nonpermanent. When a container reaches its destination and load restraint strips 110 are removed, it is desirable that little or no adhesive residue remain on the container wall. For this and other reasons, it is often desirable for the sublayer 282 to be a high shear strength pressure-sensitive acrylic adhesive that can accommodate a large temperature gradient. Because adhesive the sublayer 281 does not contact a container wall, however, adhesive residue is not a concern for this layer. Accordingly, the sublayer 281 may comprise other types of adhesives having different properties than the adhesive used for the sublayer 282. For example, the adhesive of the sublayer 281 may be selected to have higher shear and peel strengths than the adhesive of the sublayer 282 so as to ensure that the substrate sublayer 280 does not separate from the load restraint strip 110 when the strip 110 is removed from a container wall. For example, the sublayer 281 adhesive may be a rubber-based type of adhesive or could be an acrylic adhesive with a different formulation than the adhesive of the sublayer 282.

FIG. 3B is a partially schematic, truncated cross-sectional view of the load restraint strip 110 taken from the location indicated in FIG. 2B. The bold, curved truncation lines at the sides of FIG. 3B indicate that the structure shown in FIG. 3B extends throughout a portion of the attachment region 111 width W_{A} that corresponds to the handling subregion 292a associated with the 3B-3B sectioning marks in FIG. 2B. As seen in FIG. 3B, the structure of the load restraint strip 110 in the handling region 292a is similar to that shown in FIG. 3A, but without the adhesive layer 112. The handling subregion 292b, as well as handling regions on either side of the adhesive 115, may have a structure that is the same as that shown in FIG. 3B.

FIG. 3C is a partially schematic, truncated cross-sectional view of the load restraint strip 110 taken from the location indicated in FIG. 2B. The bold, curved truncation lines at the sides of FIG. 3C indicate that the structure shown in FIG. 3C extends throughout the width W_{W} of the tail 114. As seen in FIG. 3C, the structure of the load restraint strip 110 in the tail 114 is similar to the structure shown in FIG. 3A, but with the adhesive layer 112 and the liner 293a absent.

FIG. 3D is a partially schematic, truncated cross-sectional view of the load restraint strip 110 taken from the location indicated in FIG. 2C. The bold, curved truncation lines at the sides of FIG. 3D indicate that the structure shown in FIG. 3D extends throughout the width WAS of the adhesive subregion 291 after removal of the release paper liner 293a.

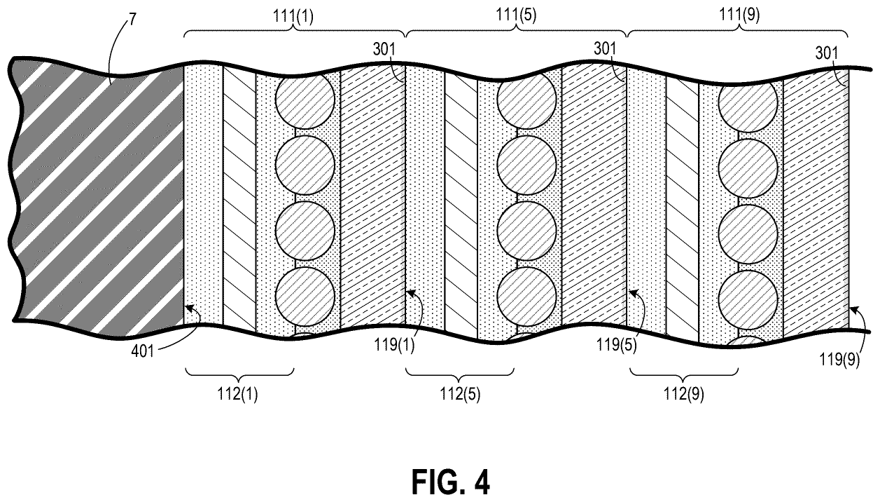

FIG. 4 is an partially schematic, truncated area cross-sectional view, from the location indicated in FIG. 1L, showing inter-bonded attachment layers 111(1), 111(5), and 111(9). The bold, curved truncation lines at the sides of FIG. 4 indicate that the structures shown in FIG. 4 adjacent to those truncation lines extend throughout the portions of the attachment regions and side wall lying within the plane of the cross-sectional view. The adhesive 112(1) of the attachment region 111(1) (of the load restraint strip 110(1)) is affixed to an interior face 401 of the left wall 7 of the cargo container 1. The adhesive 112(5) of the attachment region 111(5) (of the load restraint strip 110(5)) is affixed to the interior face 119(1) of the attachment region 111(1), and the attachment region 111(5) is secured to the wall 7 (and the cargo container 1) via the attachment region 111(1). The adhesive 112(9) of the attachment region 111(9) (of the load restraint strip 110(9)) is affixed to the interior face 119(5) of the attachment region 111(5), and the attachment region 111(9) is secured to the wall 7 (and the cargo container 1) via the attachment region 111(1) and the attachment region 111(5). Cross-sectional views taken from similar locations of wall 7 and attachment regions 111(3), 111(7), and 111(11), of wall 8 and attachment regions 111(2), 111(6), and 111(10), and of wall 8 and attachment regions 111(4), 111(8), and 111(12), would show structures and configurations similar to those shown in FIG. 4.

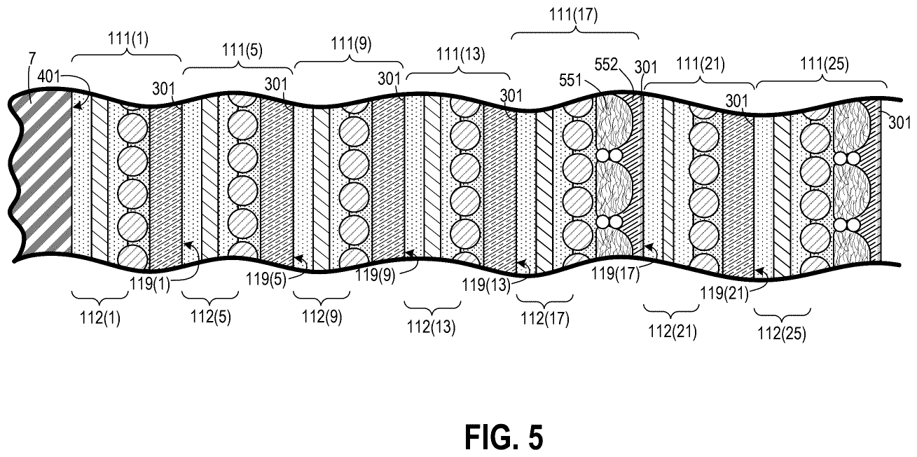

Although the example of FIGS. 1A-1M shows successively installing load restraint strips onto pre-affixed portions of other load restraint strips to result in three layers of inter-bonded attachment regions, this is only for convenience and not a limitation. For example, as shown in FIG. 5, additional layers may be added.

FIG. 5 is another partially-schematic, truncated area cross-sectional view, taken from the same location indicated in FIG. 1L, but after performance of additional cycles of steps described in FIGS. 1A-1M have resulted in additional layers of inter-bonded attachment regions. Moreover, and as further described below, FIG. 5 shows that other types of load restraint strips may be used.

As shown in FIG. 5, the adhesive 112(13) of the attachment region 111(13) (of a load restraint strip similar to the load restraint strips 110(1), 110(5), and 110(9)) is affixed to the interior face 119(9) of the attachment region 111(9), and the attachment region 111(13) is secured to the wall 7 (and the cargo container 1) via the attachment regions 111(1), 111(5) and 111(9). The adhesive 112(17) of the attachment region 111(17) is affixed to the interior face 119 (13) of the attachment region 111(13), and the attachment region 111(17) is secured to the wall 7 (and the cargo container 1) via the attachment regions 111(1), 111(5), 111(9), and 111(13). The attachment region 111(17) may be an attachment region of a load restraint strip, similar to one or more embodiments described in U.S. Pat. No. 12,059,873 (incorporated by reference herein), that comprises a base layer having a band 551 of stitchbond fabric to which a polymer film 552 has been applied or otherwise bonded, and which provides a smooth polymer interior face 119 (17) of the attachment region 111(17). The interior face 119 (17) may also comprise the surface treatment 301. The adhesive 112(21) of the attachment region 111(21) (of a load restraint strip similar to the load restraint strips 110(1), 110(5), and 110(9)) is affixed to the interior face 119 (17) of the attachment region 111(17), and the attachment region 111(21) is secured to the wall 7 (and the cargo container 1) via the attachment regions 111(1), 111(5), 111(9), 111(13), and 111(17). The adhesive 112(25) of the attachment region 111(25) (of a load restraint strip similar to the load restraint strip described in connection with the attachment region 111(17)) is affixed to the interior face 119 (21) of the attachment region 111(21), and the attachment region 111(25) is secured to the wall 7 (and the cargo container 1) via the attachment regions 111(1), 111(5), 111(9), 111(13), 111(17), and 111(121). Additional layers may be added (e.g., by performing cycles of steps described in connection with FIGS. 1A-1M). Structures and configurations, similar to those shown in FIG. 5, would be shown by: a cross-sectional view taken at a similar time as the cross-sectional view of FIG. 5 and from a similar location of wall 7 and the attachment regions 111(3), 111(7), 111(11), and subsequently added attachment regions; a cross-sectional view taken at a similar time as the cross-sectional view of FIG. 5 and from a similar location of wall 8 and the attachment regions 111(2), 111(6), 111(10), and subsequently added attachment regions; and a cross-sectional view taken at a similar time as the cross-sectional view of FIG. 5 and from a similar location of wall 8 and attachment regions 111(4), 111(8), 111(12), and subsequently added attachment regions.

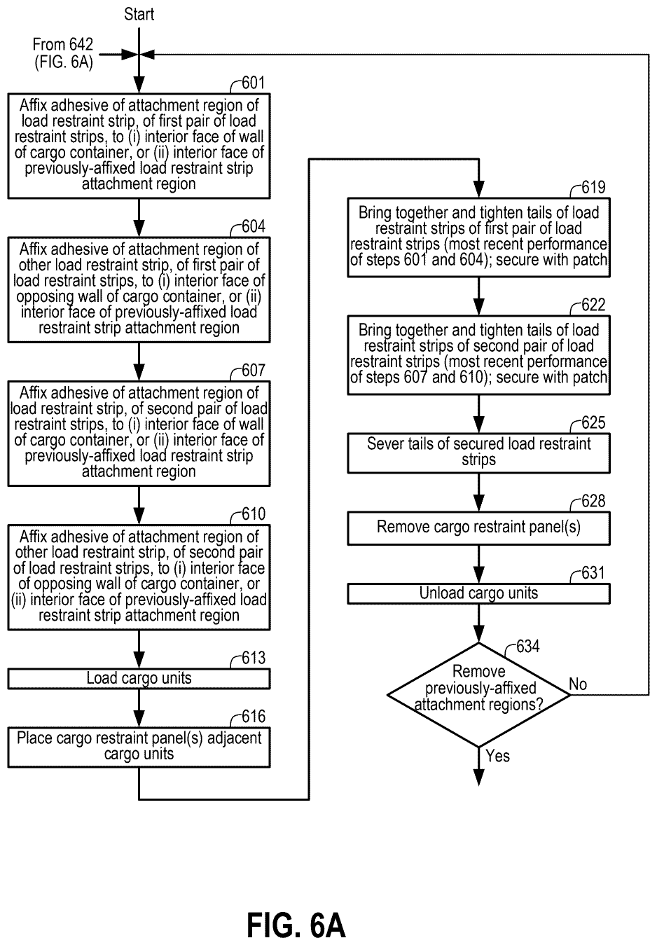

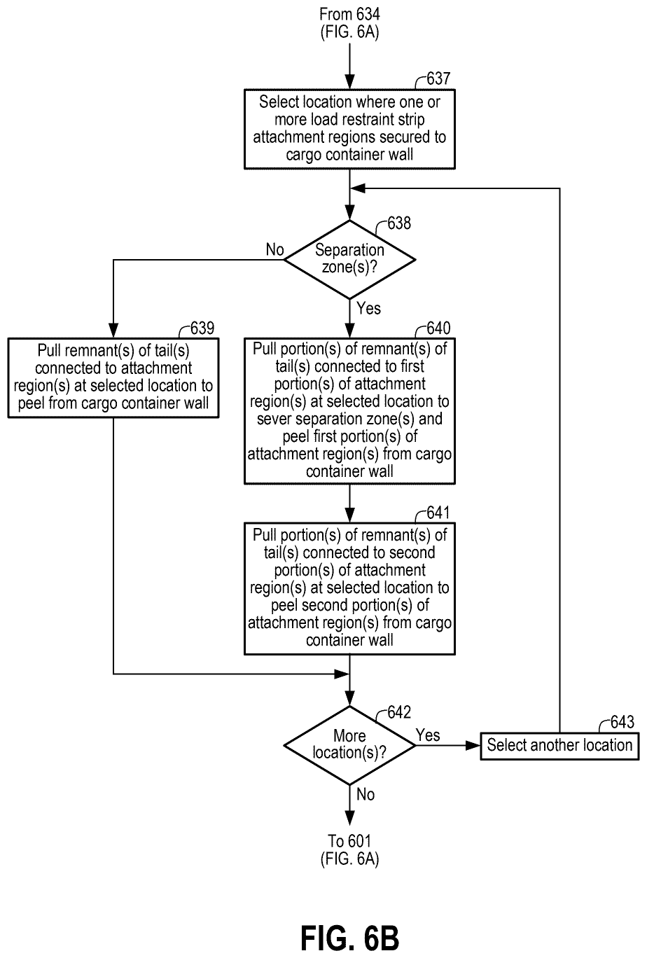

FIGS. 6A and 6B are a flow chart showing steps of an example method for securing multiple cargo loads using load restraint strips, and in which load restraint strips to secure a subsequent load may be secured to a cargo container by affixation to portions of load restraint strips that secured a previous load. Steps may be added, modified, omitted, and/or rearranged. Although some steps are described by example of load restraint strips such as the load restraint strip 110, the method of FIGS. 6A and 6B may also or alternatively be performed using load restraint strips such as the load restraint strips 110.1, 710, and/or 710.1 described subsequently herein.

In step 601, adhesive of an attachment region of a load restraint strip, of a first pair of load restraint strips, may be affixed to an interior face of a wall of a cargo container (e.g., if no previously-affixed load restraint strip attachment regions are present). An example of this is affixation (e.g., during an initial cycle of the steps of FIG. 6A) of the adhesive of the attachment region 111(1) to the interior face of the wall 7 (FIG. 1A). Alternatively, step 601 may (e.g., in a subsequent cycle of the steps of FIG. 6A) comprise affixation of adhesive of an attachment region of a load restraint strip to an interior face of a previously-affixed load restraint strip attachment region. Examples of this are affixation of the adhesive of the attachment region 111(5) to the interior face 119(1) of the attachment region 111(1) (FIG. 1I), affixation of the adhesive of the attachment region 111(9) to the interior face 119(5) of the attachment region 111(5) (FIG. 1L), or affixation of adhesive of an attachment region of a subsequent load restraint strip to the interior face 119(9) of the attachment region 111(9) or to an interior face of a subsequent attachment region in the same position as the attachment regions 111(1), 111(5), and 111(9) on the interior face of the wall 7.

In step 604, adhesive of an attachment region of the other load restraint strip, of the first pair of load restraint strips, may be affixed to an interior face of an opposing wall of the cargo container (e.g., if no previously-affixed load restraint strip attachment regions are present). An example of this is affixation (e.g., during an initial cycle of the steps of FIG. 6A) of the adhesive 112(2) of the attachment region 111(2) to the interior face of the wall 8 (FIG. 1A). Alternatively, step 604 may (e.g., in a subsequent cycle of the steps of FIG. 6A) comprise affixation of adhesive of an attachment region of a load restraint strip to an interior face of a previously-affixed load restraint strip attachment region. Examples of this are affixation of the adhesive 112(6) of the attachment region 111(6) to the interior face of the attachment region 111(2) (FIG. 1I), affixation of the adhesive 112(10) of the attachment region 111(10) to the interior face of the attachment region 111(6) (FIG. 1L), or affixation of adhesive of an attachment region of a subsequent load restraint strip to the interior face of the attachment region 111(10) or to an interior face of a subsequent attachment region in the same position as the attachment regions 111(2), 111(6), and 111(10) on the interior face of the wall 8.

In step 607, adhesive of an attachment region of a load restraint strip, of a second pair of load restraint strips, may be affixed to an interior face of a wall of a cargo container (e.g., if no previously-affixed load restraint strip attachment regions are present). An example of this is affixation (e.g., during an initial cycle of the steps of FIG. 6A) of the adhesive of the attachment region 111(3) to the interior face of the wall 7 (FIG. 1A). Alternatively, step 607 may (e.g., in a subsequent cycle of the steps of FIG. 6A) comprise affixation of adhesive of an attachment region of a load restraint strip to an interior face of a previously-affixed load restraint strip attachment region. Examples of this are affixation of the adhesive of the attachment region 111(7) to the interior face 119(3) of the attachment region 111(3) (FIG. 1I), affixation of the adhesive of the attachment region 111(11) to the interior face 119(7) of the attachment region 111(7) (FIG. 1L), or affixation of adhesive of an attachment region of a subsequent load restraint strip to the interior face 119 (11) of the attachment region 111(11) or to an interior face of a subsequent attachment region in the same position as the attachment regions 111(3), 111(7), and 111(11) on the interior face of the wall 7.

In step 610, adhesive of an attachment region of the other load restraint strip, of the second pair of load restraint strips, may be affixed to an interior face of the opposing wall of the cargo container (e.g., if no previously-affixed load restraint strip attachment regions are present). An example of this is affixation (e.g., during an initial cycle of the steps of FIG. 6A) of the adhesive 112(4) of the attachment region 111(4) to the interior face of the wall 8 (FIG. 1A). Alternatively, step 610 may (e.g., in a subsequent cycle of the steps of FIG. 6A) comprise affixation of adhesive of an attachment region of a load restraint strip to an interior face of a previously-affixed load restraint strip attachment region. Examples of this are affixation of the adhesive 112(8) of the attachment region 111(8) to the interior face of the attachment region 111(4) (FIG. 1I), affixation of the adhesive 112(12) of the attachment region 111(12) to the interior face of the attachment region 111(8) (FIG. 1L), or affixation of adhesive of an attachment region of a subsequent load restraint strip to the interior face of the attachment region 111(12) or to an interior face of a subsequent attachment region in the same position as the attachment regions 111(4), 111(8), and 111(12) on the interior face of the wall 8.

In step 613, cargo units may be loaded (or loading of cargo units previously begun may be continued). Examples include the loading of additional cargo units 5 (e.g., during an initial cycle of the steps of FIG. 6A) (FIG. 1B), the loading of the cargo units 5.1 (FIG. 1J), the loading of the cargo units 5.2, or the loading of cargo units as part of another subsequent cycle of the steps of FIG. 6A.

In step 616, one or more cargo restraint panels may be placed adjacent cargo units. Examples include placing the panel 118 against the cargo units 5 (e.g., during an initial cycle of the steps of FIG. 6A) (FIG. 1C), placing the panel 118 against the cargo units 5.1, placing the panel 118 against the cargo units 5.2, or placing the panel 118 against cargo units as part of another subsequent cycle of the steps of FIG. 6A.

In step 619, the tails of the load restraint strips of the first pair of load restraint strips, from the most recent performance of steps 601 and 604, may be brought together, tightened, and secured with a patch. Examples include bringing together, tightening, and securing the tails 114(1) and 114(2) with patch 130(1) (e.g., during an initial cycle of the steps of FIG. 6A) (FIGS. 1D-1F), bringing together, tightening, and securing the tails 114(5) and 114(6) with patch 130(3) (FIG. 1J), bringing together, tightening, and securing the tails 114(9) and 114(10) with patch 130(5) (FIG. 1M), or bringing together, tightening, and securing tails of similarly located load restraint strips as part of another cycle of the steps of FIG. 6A.

In step 622, the tails of the load restraint strips of the second pair of load restraint strips, from the most recent performance of steps 607 and 610, may be brought together, tightened, and secured with a patch. Examples include bringing together, tightening, and securing the tails 114(3) and 114(4) with patch 130(2) (e.g., during an initial cycle of the steps of FIG. 6A) (FIG. 1G), bringing together, tightening, and securing the tails 114(7) and 114(8) with patch 130(4) (FIG. 1J), bringing together, tightening, and securing the tails 114(11) and 114(12) with patch 130(6) (FIG. 1M), or bringing together, tightening, and securing tails of similarly located load restraint strips as part of another cycle of the steps of FIG. 6A.

In step 625, which may occur, for example, after the cargo container has reached a destination, the tails of the load restraint strips secured in the most recent performance of the steps 619 and 622 may be severed. Examples include severing the tails 114(1)-114(4) (e.g., during an initial cycle of the steps of FIG. 6A) (FIG. 1H), severing the tails 114(5)-114(8) (FIG. 1K), severing the tails 114(9)-114(12), or severing the tails of load restraint strips as part of another cycle of the steps of FIG. 6A. In step 628, the cargo restraint panel placed during the most recent performance of step 616 may be removed. In step 631, cargo units (e.g., loaded during the most recent performance of step 613) may be unloaded.

In step 634, there may be a determination of whether previously-affixed attachment regions should be removed from interior faces of the cargo container walls. For example, accumulated previously-affixed attachment regions may be removed if the thickness of the accumulated regions has reached some predetermined value (e.g., 0.5 inches, 1 inch) and/or if the accumulated previously-affixed attachment regions comprise a predetermined number of layers (e.g., 5, 10, 15, or more). Also or alternatively, accumulated previously-affixed attachment regions may be removed as part of scheduled maintenance and/or cleaning of the cargo container.

If the determination in step 634 is that the previously-affixed attachment regions should not be removed, another cycle of steps of FIG. 6A may start again with step 601. If the determination in step 634 is that the previously-affixed attachment regions should be removed, step 637 (FIG. 6B) may be performed.

In step 637, a location in a cargo container, where one or more load restraint strip attachments regions may be secured to a wall of a cargo container, may be selected. Each of those locations may be a location where a single attachment region is secured to a wall or where multiple inter-bonded attachment regions are secured to a wall. If the attachment region(s) at the selected location lack separation zones (such as are described below), and as indicated by the “no” branch from step 638, the attachment region(s) secured at the selected location may be removed in a single step 639. In step 639, remnant(s) of tail(s) connected to the attachment region(s) at the selected location may be pulled so as to exert a peel/tensile force on the adhesive of the attachment region adjacent to the container wall. That pulling force may peel that attachment region, and other attachment regions(s) inter-bonded with that attachment region (if any), from the container wall. After step 639, step 642 may be performed.

If the attachment region(s) at the selected location have separation zones (such as are described below), and as indicated by the “yes” branch from step 638, the attachment region(s) secured at the selected location may be removed in two steps 640 and 641. In step 640, portions of remnant(s) of tail(s) connected to first portions(s) of the attachment region(s) at the selected location may be pulled so as to sever separation zone(s) and exert a peel/tensile force on the adhesive of a first attachment region portion adjacent to the container wall. That pulling force may peel that first attachment region portion, and other first attachment region portion(s) inter-bonded with that first attachment region portion (if any), from the container wall. Examples of step 640 are described in more detail below. In step 641, remnant(s) of tail(s) connected to second portions(s) the attachment region(s) at that location may be pulled so as to exert a peel/tensile force on the adhesive of a second attachment region portion adjacent to the container wall. That pulling force may peel that second attachment region portion, and other second attachment regions portion(s) inter-bonded with that second attachment region portion (if any), from the container wall. An example of step 641 is described in more detail below. After step 641, step 642 may be performed.

In step 642, there may be a determination of whether there are additional locations in the cargo container where one or more load restraint strip attachment regions remain secured to a wall of the cargo container. If yes, one of those locations may be selected in step 643, and steps 638 and 639 (or steps 638, 640, and 642) may be performed at that location. If no, step 601 and subsequent steps may be repeated.

As indicated above, one or more steps of the example method of FIGS. 6A and 6B may be modified, omitted, or rearranged. For example, in some circumstances only a single pair of load restraint strips (e.g., a pair of load restraint strips have widths W_{W} of 32 inches or more) may be used. In such circumstances, steps 607, 610, and 622 may be omitted during one or more cycles of the steps of FIG. 6A. As but another example, a cargo restraint panel may not be used for some loads, and steps 616 and 628 may be omitted during one or more cycles of the steps of FIG. 6A. All load restraint strips used during a particular cycle, and/or load restraint strips used in different cycles, need not be the same. For example one or more load restraint strips used during a particular cycle may be similar the load restraint strip 110, and one or more other load restraint strips used during that cycle may have a structure such as that described in U.S. Pat. No. 12,059,873.

Increasing widths of load restraint strips (e.g., a width W_{W} shown in FIG. 2C) provides numerous advantages. For example, increasing a width of a load restraint strip increases the quantity of reinforcing strands (e.g., the reinforcing strands 288) in the load restraint strip, as well as the area of the adhesive layer in the attachment region (e.g., the adhesive layer 112 in the attachment region 111) of the load restraint strip. The net result of increase reinforcement strands and adhesive layer area is an increase in the load-securing capacity (e.g., load weight) of the load restraint strip. Moreover, the greater width of the load restraint strip provides more surface area for the tail of the load restraint strip, thereby providing greater surface area that acts against a restrained load.

However, increasing a width of a load restraint strip may have a disadvantage under some circumstances. In particular, the increased surface area of the load restraint strip increases the amount of pull force needed to remove a load restraint strip attachment region (or a stack, comprising multiple layers of attachment regions, formed by successively affixing attachment regions of new load restraint strips to previously-affixed attachment regions of old load restraint strips) from a wall of a cargo container. For some workers, this may cause difficulty when removing attachment regions and/or slow the removal process.

To address this disadvantage, a load restraint strip may comprise a longitudinally-extending separation zone. This separation zone, which may extend along a lengthwise direction of the load restraint strip through at least the attachment region, may comprise one or more rows of perforations that allow the attachment region to be separated into multiple pieces during removal from a cargo container wall, thereby significantly reducing the amount of pull force needed to remove attachment regions from cargo container walls.

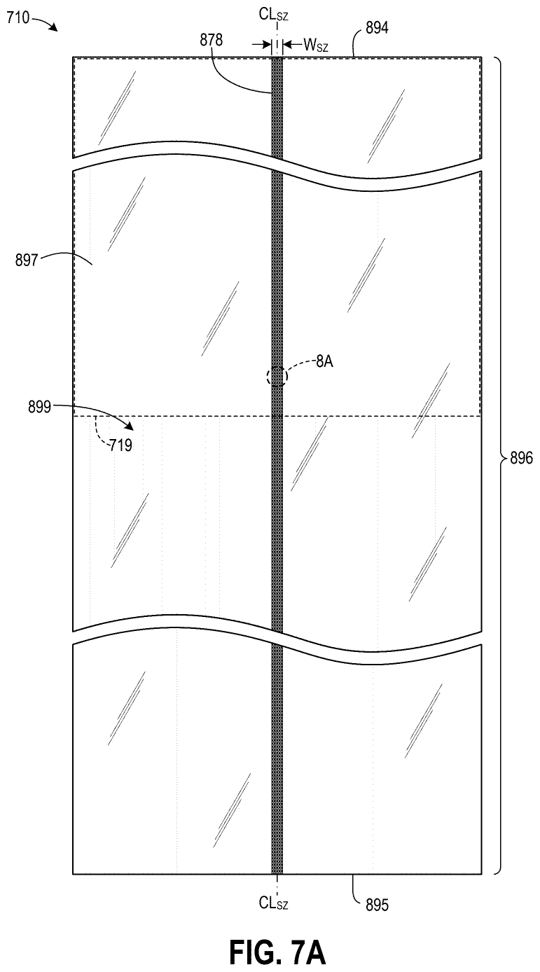

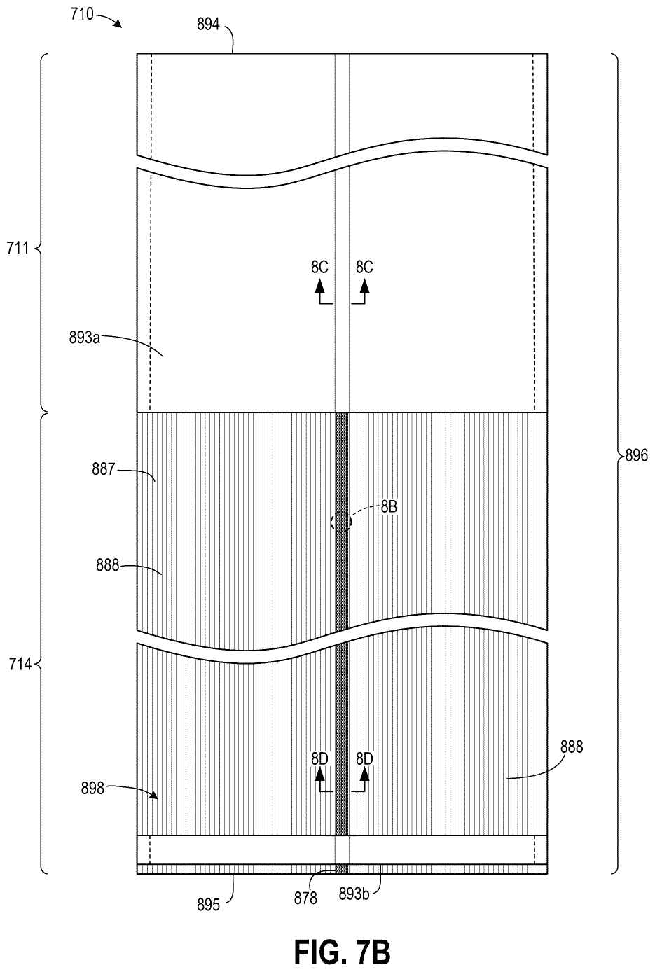

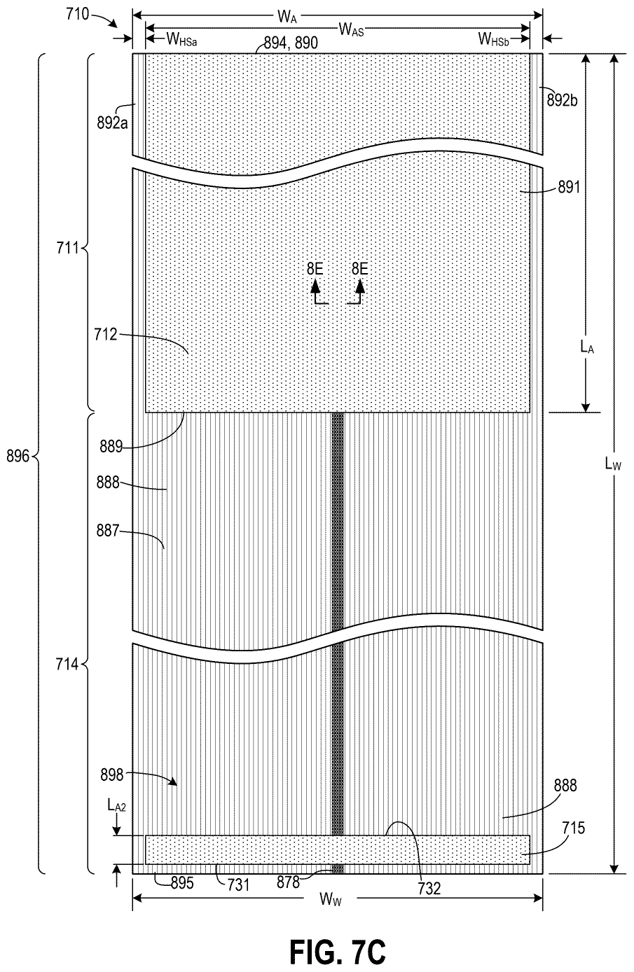

FIG. 7A is a partially schematic plan view showing an interior face 899 of an example load restraint strip 710 that comprises a longitudinally-extending separation zone 878. Also indicated is an interior face 719 of an attachment region 711(shown in FIG. 7B) of the load restraint strip 710. The load restraint strip 710 may be used in the same manner as the load restraint strip 110. For example, the load restraint strip 710 is also configured to facilitate methods, such as those described herein, for securing multiple cargo loads using load restraint strips, and in which load restraint strips to secure a subsequent load may be secured to a cargo container by affixation to portions of load restraint strips that secured a previous load. Except as otherwise described herein, the load restraint strip 710 may have a structure similar to (and/or may comprise variations such as those described for) that of the load restraint strip 110. The load restraint strip 710 may comprise a band 897 of polymer material that forms a base layer of the load restraint strip 710. The band 897 may, except as otherwise described herein, be the same as (or similar to, and/or may comprise variations such as those described for) the band 297. The load restraint strip 710 has a working portion 896 that may extend the entire length of the load restraint strip 710 from a first strip end 895 to a second strip end 894. However, a working portion of a load restraint strip may be less than the entire length of that load restraint strip. Multiple load restraint strips 710 may be joined together and wound on a roll. Widthwise direction lines and/or perforations (not shown) may separate ends 894 and 895 of adjacent load restraint strips 710 on that roll. The load restraint strips 710 can be removed from the roll by tearing and/or cutting along the lines and/or perforations between ends 894 and 895 of adjacent load restraint strips 710.

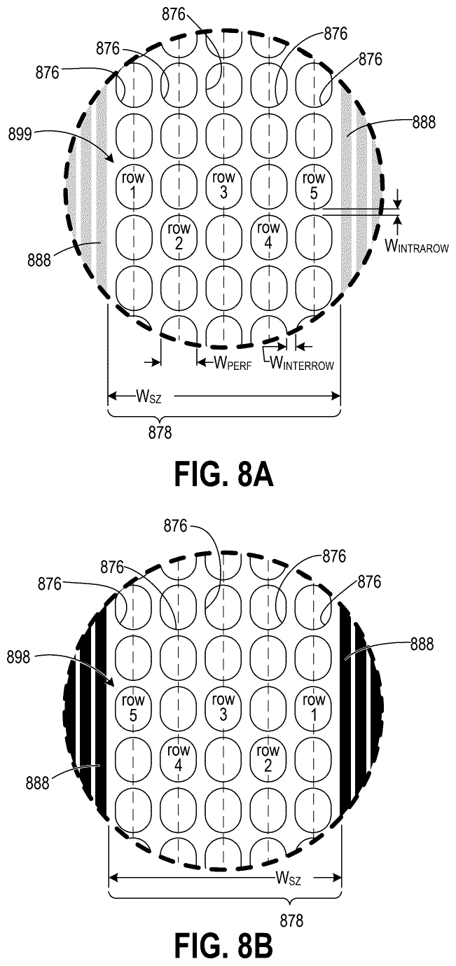

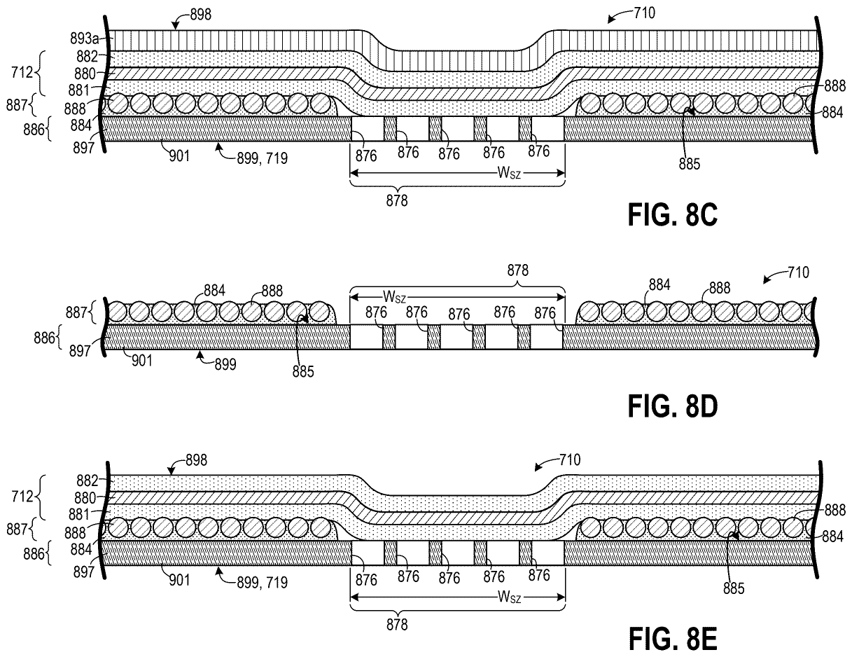

The separation zone 878 may extend from the strip end 894 to the strip end 895. As described in further detail in connection with FIGS. 8A-8E, the separation zone 878 may comprise multiple rows of perforations in the band 897. A longitudinal centerline CL_{SZ} of the separation zone 878 may be centered (or approximately centered, e.g., +/−10%) in a widthwise direction of the load restraint strip 710. Alternatively, the longitudinal centerline CL_{SZ} of the separation zone 878 may be closer to one edge of the load restraint strip 710. For example, for a load restraint strip 710 having a width W_{W} (shown in FIG. 7C) of 32 inches, the longitudinal centerline CL_{SZ} of the separation zone 878 may be 12 inches from one edge of the load restraint strip 710 and 20 inches from the other edge of the load restraint strip 10. The separation zone 878 may have a width W_{SZ} of, for example, approximately (e.g., +/−10%) 0.5 inches.

FIG. 7B is a partially schematic plan view showing an exterior face 898 of the load restraint strip 710. FIG. 7B shows the exterior face 898 of the load restraint strip 710 in a lined configuration. In particular, and as explained in further detail below, a release paper liner 893a is attached to cover an adhesive layer in the attachment region 711 and a release paper liner 893b is attached to cover another adhesive region used to temporarily support a tail 714 during installation of the load restraint strip 710. The release paper liners 893a and 893b may respectively be the same (as or similar) to the release paper liners 293a and 293b. FIG. 7C is another partially schematic plan view showing the exterior face 898 of the load restraint strip 710, but with the release paper liner 893a removed to expose an adhesive layer 712 and the release paper liner 893b removed to expose an adhesive layer 715. The adhesive layers 712 and 715 may respectively be the same as (or similar to, and/or may comprise variations such as those described for) the adhesive layers 112, and 115. Once exposed by removal of the liner 893a, the adhesive layer 712 can be pressed against an interior face of a wall of a cargo container, or to an exposed attachment region interior face 719 of a previously-affixed attachment region 711 of a previously used load restraint strip 710, so as to secure the attachment region 711 of the load restraint strip 710 to that container wall interior face. A tail 714 of the load restraint strip 710 may then extend away from attachment region 711. That tail 714 may, after securing of the attachment region 711, initially extend along the container wall and be supported by the adhesive 715. As described above, a tail 714 may subsequently be wrapped around cargo (and around a cargo restraint panel, if used) and then tightened with, and secured to, a tail of another load restraint strip. The broken lines extending lengthwise in the attachment region 711 in FIG. 7B indicate edges of the adhesive layer 712 in the attachment region 711, as well as edges of handling subregions 892a and 892b shown in FIG. 7C. The broken lines shown extending lengthwise on the liner 893b similarly indicate edges of the adhesive 715, as well as edges of handling subregions similar to subregions 892a and 892b.

In the example of the load restraint strip 710, the adhesive layer 712 extends throughout an adhesive subregion 891 of the attachment region 711. The adhesive subregion 891 has a width WAS. The handling subregions 892a and 892b have respective widths W_{HSa} and W_{HSb} and extend from edges of the adhesive subregion 891 to side edges of the load restraint strip 710. An end 890 of the adhesive layer 712, the attachment subregion 891, and the attachment region 711 is aligned with the end 894 of the load restraint strip 110 and of the working portion 896. Alternatively, the end 890 of the adhesive layer 712 may be near (e.g., within 3 inches) of the end 894 of the load restraint strip 710. An end 889 of the adhesive layer 712, the attachment subregion 891, and the attachment region 711 is located at an intermediate location between the end 894 and the end 895 of the load restraint strip 710 and of the working portion 896. As indicated in FIG. 7C, the working portion 896 has a length L_{W} and a width W_{W}. The attachment region 711 has a length L_{A} and width W_{A}, and W_{A} may equal W_{W}. The handling subregions 892a and 892b may be sub-regions of the attachment region 711 in which the adhesive of the adhesive layer 712 has been omitted, and which may provide convenient regions for a worker to grip the attachment region during installation of the load restraint strip 710. Widths W_{HSa} and W_{HSb} of the handling subregions 892 may, for example, be between 1 and 2 inches. The length L_{W} may, for example, be between 9 and 14 feet (e.g., 12 feet). The length L_{A} may, for example, be between 2 and 6 feet (e.g., 5 feet). The width W_{W} may, for example, be between 10 and 50 inches (e.g., 16 inches., 32 inches, 36 inches, or 40 inches). Optionally, W_{A} may be less than W_{W}, and/or the handling subregions 892 may be omitted (e.g., the adhesive of the adhesive region 712 may extend to side edges of the attachment region 711).

As seen in FIGS. 7B and 7C, and as discussed more fully below, the load restraint strip 710 includes a plurality of reinforcing strands 888 in a reinforcement layer 887. Except as described below in connection with the separation zone 878, the reinforcement layer 887 may be the same as (or similar to, and/or may comprise variations such as those described for) reinforcement layer 287. The strands 888, which are indicated as black lines on exterior face 898, may be the same as (or similar to, and/or may comprise variations such as those described for) the strands 888. To avoid obscuring FIGS. 7B and 7C with unnecessary detail, the number of black lines is significantly less than the number of reinforcing strands that may be present in an actual load restraint strip 710. Moreover, the strands 888 could be white, off-white, or otherwise lightly colored, translucent, or transparent. In the example of the load restraint strip 710, and as shown in FIGS. 7B and 7C, the reinforcement strands 888 only extend in a direction parallel to the length L_{W} of the load restraint strip 710.

The adhesive 715, which may comprise an adhesive similar to that of the adhesive layer 712, may have a length L_{A2} (e.g., 1 to 12 inches). An edge 731 of the adhesive 715 may be aligned with, or be near (e.g., within 12 inches) the end 895 of the load restraint strip 110. An edge 732 of the adhesive 715 may be separated from the edge 889 of the adhesive region 712 by a region of the exterior face 898 in which active adhesive is absent. An active adhesive may comprise an adhesive that is uncured, has not set, and/or that is not pressure-sensitive (e.g., would not adhere to support the load restraint strip 710 if pressed into contact with a container wall or other vertical surface). Conversely, an adhesive that has set, been cured, and/or is not pressure-sensitive may be inactive, even if that adhesive is still forming a bond (e.g., a bond between reinforcing strands and 888 and the band 887).

FIG. 8A is an enlarged view of the portion of the interior face 899 of the load restraint strip 710 indicated in FIG. 7A. FIG. 8B is an enlarged view of the portion of the exterior face 898 of the load restraint strip 710 indicated in FIG. 7B. The separation zone 878 may comprise multiple rows of perforations 876. Each of the rows may extend from the end 894, through the attachment region 711, and through at least a portion of the tail 714 that is adjacent to the attachment region 711. In the example of FIGS. 7A-8E, each of the rows extends the entire length of the load restraint strip from the end 894 to the end 895.

In the example of FIGS. 7A-8E, and as shown in FIGS. 8A and 8B by the broken lines labelled “row 1” through “row 5,” the separation zone 878 comprises 5 rows of perforations 876. A separation zone may have more or fewer rows of perforations. A separation zone may have a single row of perforations. Each perforation may have a width W_{PERF}. The width W_{PERF} may be the same (or substantially the same, e.g., +/−10%) for all perforations 876 or may be different for all perforations 876. The perforations 876 in the example of FIGS. 8A and 8B have rounded shapes that are elongated along the longitudinal directions of the rows 1-5. Also or alternatively, perforations 876 may have other shapes (e.g., oval, rectangular, circular, star-shaped). All perforations 876 in a row need not have the same shape. Perforations 876 in one row may have shapes different from perforations 876 in another row. Distances between perforations in a row may be uniform or may vary. Distances between rows may be uniform or may vary. As but one non-limiting example, perforations 876 may have a width W_{PERF} of approximately (e.g., +/−10%) 0.08 inches, there may be spaces W_{INTERROW} of approximately (e.g., +/−10%) 0.02 inches between perforations 876 in adjacent rows, and there may be spaces W_{INTRAROW} of approximately (e.g., +/−10%) 0.015 inches between adjacent perforations 876 in a single row.

FIG. 8C is a partially schematic, truncated cross-sectional view of the load restraint strip 710 taken from the location indicated in FIG. 7B. FIG. 8C shows elements of the attachment region 711 when the load restraint strip 710 is in a lined configuration, i.e., with release paper liner 893a in place. The bold, curved truncation lines at the sides of FIG. 8C indicate that the structure shown at the left and right sides of FIG. 8C extends, throughout the adhesive subregion 891 of the attachment region 711, to the handling regions 892a and 892b. In the handling regions 892a and 892b, the load restraint strip 710 may have a structure that is the same as (or similar to, and/or may comprise variations such as those described for) the structure of the handling regions 292a and 292b.

In addition to the adhesive layer 712 and the reinforcement layer 887, the load restraint strip 710 includes a base layer 886. The reinforcement layer 887 and the base layer 886 extend throughout the entire length of working portion 896 of the load restraint strip 710, whereas the attachment layer 712 is confined to the attachment region 711. The base layer 886 may comprise the band 897 of polymer material. The band 897 may be nonporous. The band 897 may, except for the perforations 876, have a structure that is the same as (or similar to, and/or may comprise variations such as those described for) the band 297. The interior face 719 of the attachment region 711, or the entire interior face 899 of the load restraint strip 710, may comprise a surface treatment 901 (FIG. 8C and in subsequent FIGS. as a gray band) that is the same as (or similar to, and/or may comprise variations such as those described for) the surface treatment 301. The surface treatment 901 is optional. As shown in FIGS. 80-8E, the perforations 878 extend all the way through the band 897 and the base layer 886.

The reinforcement layer 887 is fixed relative to the base layer 886. In particular, the reinforcement strands 888 are bonded to an exterior face 885 of the band 897 by a laminating adhesive 884. The reinforcement strands 888 may be parallel to one another and to the length L_{W} direction of working portion 896, and the load restraint strip 710 may omit reinforcement strands oriented in other directions. The reinforcement strands 888 and the laminating adhesive 884 may respectively be the same as (or similar to, and/or may comprise variations such as those described for) the reinforcement strands 288 and the laminating adhesive 284. The reinforcement strands 888 and the laminating adhesive 884 may be absent from the separation zone 878. For example, the reinforcement strands 888 and the laminating adhesive may extend from one lengthwise edge of the load restraint strip 710 to a first side of the separation zone 878 (e.g., the left side of the separation zone 878 in FIGS. 8C-8E) and from a second side of the separation zone 878(e.g., the right side of the separation zone 878 in FIGS. 8C-8E) to the other lengthwise edge of the load restraint strip 710. The load restraint strip 710 may have, in regions other than the separation zone, a strand distribution density (e.g., between 6.25 and 20 strands per inch, between 5 and 25 strands per inch) that is the same as (or similar to, and/or may comprise variations such as those described for) that of the load restraint strip 100.

The adhesive layer 712 is fixed relative to reinforcement layer 887, and relative to the base layer 886. The adhesive layer 712 may be the same as (or similar to, and/or may comprise variations such as those described for) the adhesive layer 112. Unlike the reinforcement layer 887 and the base layer 886, however, and as seen in FIG. 7C, the adhesive layer 712 is confined to attachment region 711. The adhesive layer 712 may, for example, comprise a first adhesive sublayer 882, a second adhesive sublayer 881 and a substrate sublayer 880. The substrate sublayer 880 at least partially separates the adhesive sublayers 882 and 881. The first adhesive sublayer 882, the substrate sublayer 880, and the second adhesive sublayer 881 may respectively be the same as (or similar to, and/or may comprise variations such as those described for) the first adhesive sublayer 282, the substrate sublayer 280, and the second adhesive sublayer 281. The substrate 880 may include holes or other perforations permitting direct contact between the adhesive sublayers 882 and 881 in certain areas. The substrate 880 may optionally be omitted. The release paper liner 893a, which may be the same as (or similar to, and/or may comprise variations such as those described for) the release paper liner 293a, is affixed to the exterior side of the adhesive sublayer 882 when the load restraint strip 710 is in a lined configuration.

FIG. 8D is a partially schematic, truncated cross-sectional view of the load restraint strip 710 taken from the location indicated in FIG. 7B. The bold, curved truncation lines at the sides of FIG. 8D indicate that the structure shown at the right and left sides in FIG. 8D extends throughout the width W_{W} of the tail 714. As seen in FIG. 8D, the structure of the load restraint strip 710 in the tail 714 is similar to the structure shown in FIG. 80, but with the adhesive layer 712 and the liner 893a absent.

FIG. 8E is a partially schematic, truncated cross-sectional view of the load restraint strip 710 taken from the location indicated in FIG. 7C. The bold, curved truncation lines at the sides of FIG. 3D indicate that, after removal of the release paper liner 893a, the structure shown at the left and right sides of FIG. 8E extends, throughout the adhesive subregion 891, to the handling regions 892a and 892b.

In the region of the adhesive 715, the load restraint strip 710 may have a structure that is the same as (or similar to, and/or may comprise variations such as those described for) the structure shown in FIG. 8C (before removal of release paper liner 893b) or in FIG. 8D (after removal of release paper liner 893b). The regions between edges of the adhesive 715 and the edges of the load restraint strip 710 may have a structure that is the same as (or similar) the structure of the handling regions 892a and 892b.

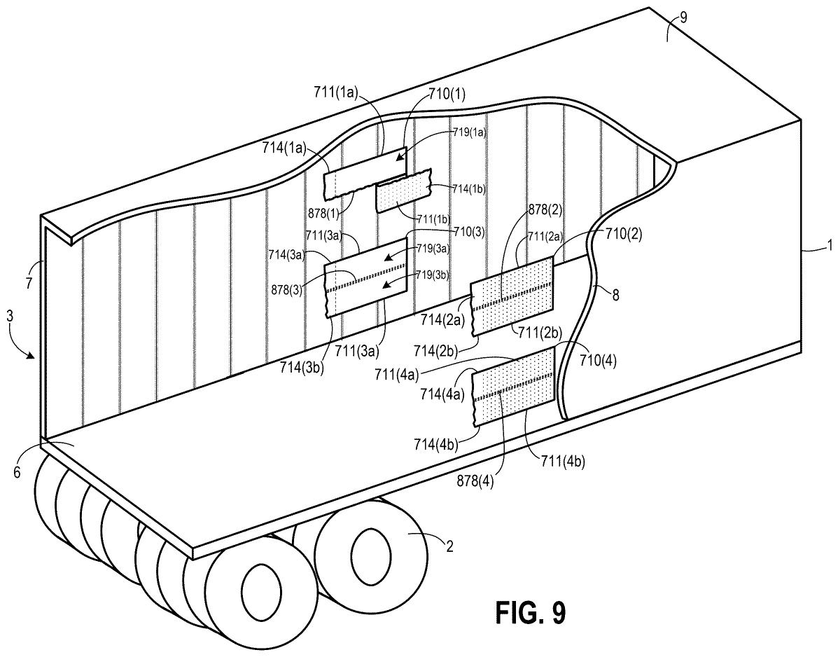

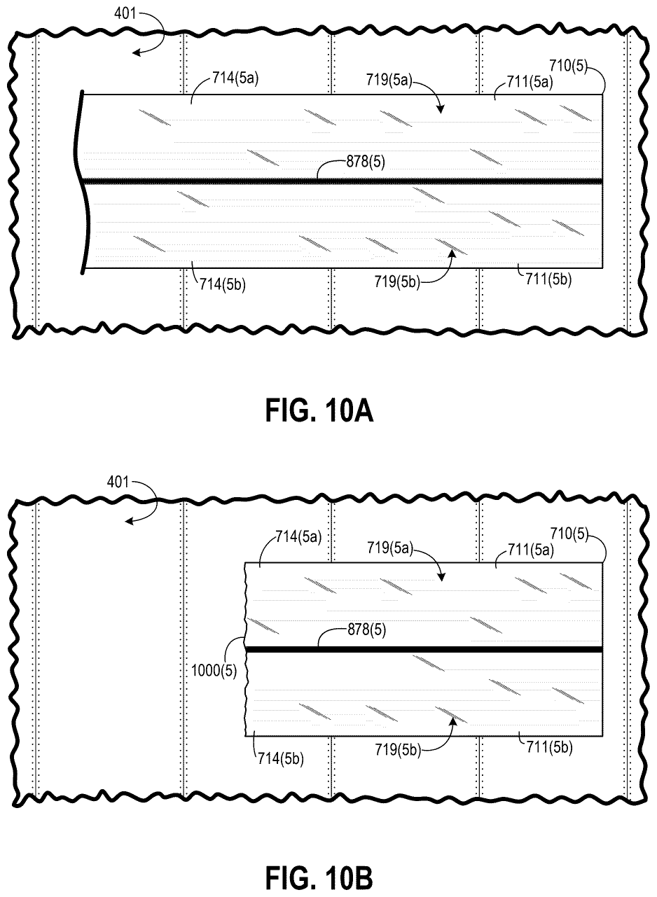

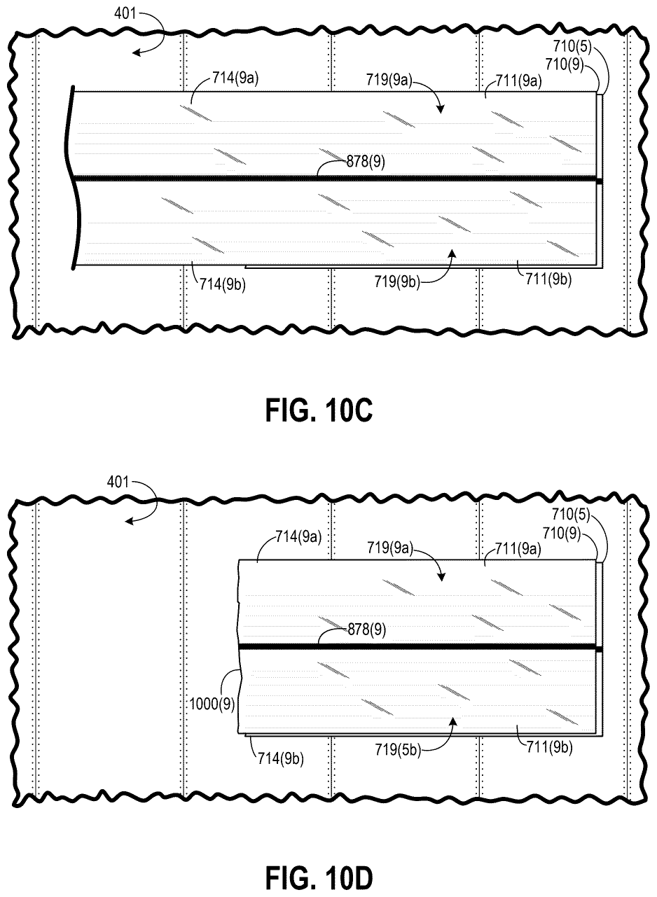

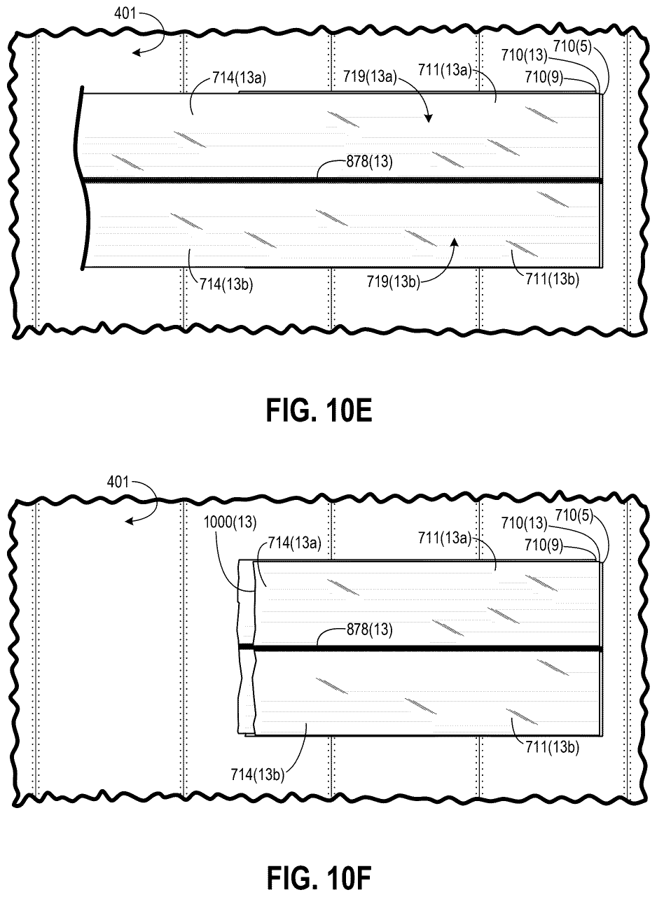

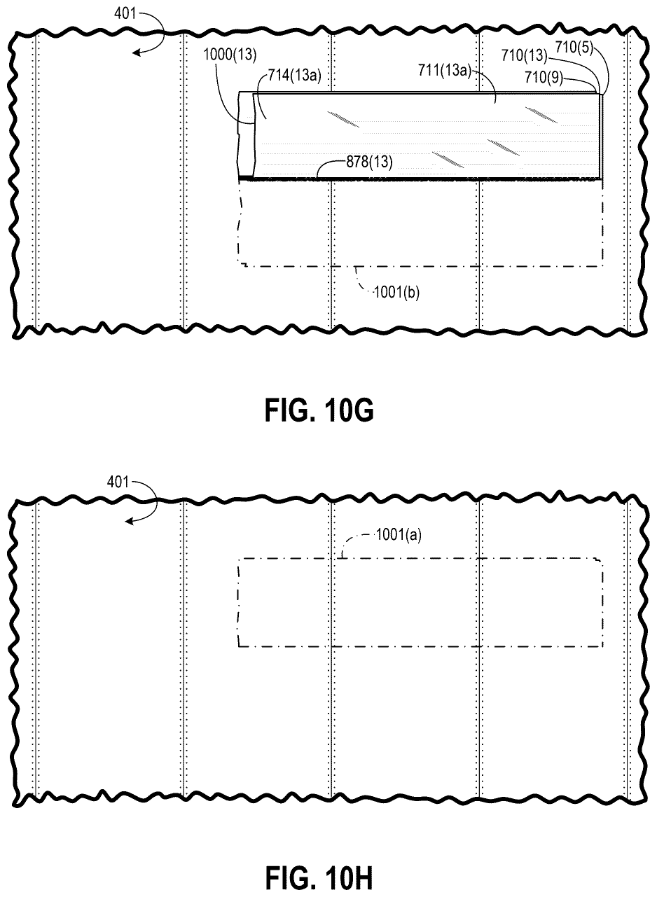

FIG. 9 shows an example of how the separation zone 878 may reduce pull force needed to remove an attachment region 711 of a load restraint strip 710 from a wall of a cargo container. For convenience, portions of the attachment regions 711, tails 714, and attachment region interior faces 719 on opposite sides of separation zones 878 of load restraint strips 710 in FIGS. 9-10H are assigned separate reference numbers. For example, FIG. 9 shows: attachment region portions 711(1a) and 711(1b), remaining segments of tail portions 714(1a) and 714(1b), separation zone 878(1), and attachment region interior face portion 719(1a) of load restraint strip 710(1); attachment region portions 711(2a) and 711(2b), remaining segments of tail portions 714(2a) and 714(2b), and separation zone 878(2) of load restraint strip 710(2); attachment region portions 711(3a) and 711(3b), remaining segments of tail portions 714(3a) and 714(3b), separation zone 878(3), and attachment region interior face portions 719(3a) and 719(3b) of load restraint strip 710(3); and attachment region portions 711(4a) and 711(4b), remaining segments of tail portions 714(4a) and 714(4b), and separation zone 878(4) of load restraint strip 710(4). When referring to two parts of load restraint strip on opposite sides of a separation zone 878 that have not been separated (e.g., a corresponding part the separation zone 878 still joins those two parts), those two parts will be referred to as a single part using a “/” to join the reference characters of the two parts. For example, attachment region 711(1a)/711(1b) comprises the attachment region portions 711(1a) and 711(1b) that are still joined together by the portion of attachment region 878(1) between attachment region portions 711(1a) and 711(1b).

Prior to the condition shown in FIG. 9, the load restraint strips 710(1)-710(4), each of which may have the structure of the load restraint strip 710 described in connection with FIGS. 7A-8E, were put into place to result in a configuration similar to that shown in FIG. 1A. The attachment region 711(1a)/711(1b) of the load restraint strip 710(1) and the attachment region 711(3a)/711(3b) of the load restraint strip 710(3) were affixed to the interior face of the wall 7 by placing the adhesive 712 of the load restraint strip 710(1) and the adhesive 712 of the load restraint strip 710(3) into contact with the interior face of the wall 7. The attachment region 711(2a)/711(2b) of the load restraint strip 710(2) and the attachment region 711(4a)/711(4b) of the load restraint strip 710(4) were affixed to the interior face of the wall 8 by placing the adhesive 712 of the load restraint strip 710(2) and the adhesive 712 of the load restraint strip 710(4) into contact with the interior face of the wall 8. Adhesive 715 of the load restraint strip 710(1) and of the load restraint strip 710(3) was also placed into contact with the interior face of the wall 7 to support the tail 714(1a)/714(1b) of the load restraint strip 710(1) and the tail 714(3a)/714(3b) of the load restraint strip 710(3), similar to how shown for the load restraint strips 110(1) and 110(3) in FIG. 1A. Adhesive 715 of the load restraint strip 710(2) and of the load restraint strip 710(4) was placed into contact with the interior face of the wall 8 to support the tail 714(2a)/714(2b) of the load restraint strip 710(2) and the tail 714(4a)/714(4b) of the load restraint strip 710(4), similar to how shown for the load restraint strips 110(2) and 110(4) in FIG. 1A. Cargo units (or additional cargo units) were next loaded, resulting in a condition similar to that shown in FIG. 1B (but with the load restraint strips 710(1)-710(4) instead of the load restraint strips 110(1)-110(4)). Next a cargo restraint panel 118 was placed against a rear face of the stack of cargo units, resulting in a condition similar to that shown in FIG. 1C (but with the load restraint strips 710(1)-710(4) instead of the load restraint strips 110(1)-110(4)). Next, the tail 714(1a)/714(1b) of the load restraint strip 710(1) and the tail 714(2a)/714(2b) of the load restraint strip 710(2) were pulled away from the interior faces of the wall 7 and the wall 8 and wrapped around the cargo restraint panel 118, similar to how shown in FIG. 1D for the tails 114(1) and 114(2) of the load restraint strips 110(1) and 110(2). Next, the tails 714(1a)/714(1b) and 714(2a)/714(2b) were tightened and secured with an adhesive patch, similar to how shown and described for the tails 114(1) and 114(2) in FIGS. 1E and 1F. Next, the tail 714(3a)/714(3b) of the load restraint strip 710(3) and the tail 714(4a)/714(4b) of the load restraint strip 710(4) were, in a similar manner, pulled away from the interior faces of the walls 7 and 8, wrapped around the cargo restraint panel 118, tightened, and secured with an adhesive patch, resulting in a condition similar to that shown in FIG. 1G (but with the load restraint strips 710(1)-710(4) instead of the load restraint strips 110(1)-110(4)). Subsequently, the tails 714(1a)/714(1b), 714(2a)/714(2b), 714(3a)/714(3b), and 714(4a)/714(4b) were severed (e.g., by cutting with a knife), the cargo restraint panel 118 removed, and the cargo unloaded.

FIG. 9 shows the cargo container 1 in a condition similar to that shown in FIG. 1H. But in the example of FIG. 9, unlike the example of FIG. 1H, attachment regions of new load restraint strips will not be placed onto attachment region interior face 719(1a)/719(1b), attachment region interior face 719(3a)/719(3b), or attachment region interior faces of the load restraint strips 710(2) and 710(4). In FIG. 9, removal of attachment regions 711(1a)/711(1b) has begun. In particular, the segment of tail portion 714(1b) that remained after severing the tail 714(1a)/714(1b) has been grasped (by a worker, not shown) and pulled so as to both tear along the separation zone 878(1) and exert a peel/tensile force on the portion of the adhesive 712 securing the attachment region portion 711(1b) to the interior face of the wall 7. The amount of pull force needed to both sever the separation zone 878(1) and peel the attachment region portion 711(1b) away from the interior face of the wall 7 is significantly less than the amount of pull force that would be needed to peel an entire attachment region, of similar size as the attachment region 711(1a)/711(1b) but without a separation zone, from the interior face of the wall 7. After the attachment region portion 711(1b) has been removed, the attachment region portion 711(1a) may be removed by grasping the segment of the tail portion 714(1a) that remained after severing the tail 714(1a)/714(1b) and by pulling so as to exert a peel/tensile force on the portion of the adhesive 712 securing the attachment region portion 711(1a) to the interior face of the wall 7. The attachment region portions 711(2a), 711(2b), 711(3a), 711(3b), 711(4a), and 711(4b) may be removed in a similar manner.

FIGS. 10A-10H show an example of how separation zones may reduce pull force needed to remove multiple layers of inter-bonded attachment regions. For convenience, FIGS. 10A-10H only show operations performed for one location on an interior face 401 of the wall 7 (e.g., the location where attachment regions 111(1), 111(5), and 111(9) were secured in the example of FIGS. 1A-1M). Operations similar to those shown in FIGS. 10A-10H and described below may similarly be performed at other locations (e.g., the location on face 401 where the attachment regions 111(3), 111(7), and 111(11) were secured in the example of FIGS. 1A-1M, the location on the interior face of the wall 8 where the attachment regions 111(2), 111(6), and 111(10) were secured in the example of FIGS. 1A-1M, and/or the location on the interior face of the wall 8 where the attachment regions 111(4), 111(8), and 111(12) were secured in the example of FIGS. 1A-1M) as part of performing method according to FIGS. 1A-1M, 6A, and 6B using load restraint strips 710 instead of load restraint strips 110.

In FIG. 10A, the adhesive 712 (not visible in FIG. 10A) of the attachment region 711(5a)/711(5b) of the load restraint strip 710(5) has been placed into contact with the interior face 401 to secure the attachment region 711(5a)/711(5b) to the cargo wall 7. Although not shown, the adhesive 715 of the load restraint strip 710(5) may be affixed to the interior face 401 to support the tail 714(5a)/714(5b) of the load restraint strip 710(5). In FIG. 10B, the tail 714(5a)/714(5b) has been severed along a cut line 1000(5), leaving the attachment region 711(5a)/711(5b) secured to the wall face 401 and a segment of the tail 714(5a)/714(5b) between the cut line 1000(5) and the attachment region 711(5a)/711(5b).

In FIG. 10C, the adhesive 712 (not visible in FIG. 10C) of the attachment region 711(9a)/711(9b) of the load restraint strip 710(9) has been placed into contact with the interior face 719(5a)/719(5b) of the attachment region 711(5a)/711(5b) of the load restraint strip 710(5). This affixes the attachment region 711(9a)/711(9b) to the attachment region 711(5a)/711(5b), thereby securing the attachment region 711(9a)/711(9b) of the load restraint strip 710(9) to the cargo wall 7 via the attachment region 711(5a)/711(5b) of the load restraint strip 710(5). Although not shown, the adhesive 715 of the load restraint strip 710(9) may be affixed to the interior face 401 to support the tail 714(9a)/714(9b) of the load restraint strip 710(9). In FIG. 10D, the tail 714(9a)/714(9b) has been severed along a cut line 1000(9), leaving the attachment region 711(9a)/711(9b) secured to the wall face 401 (via the attachment region 711(5a)/711(5b)) and a segment of the tail 714(9a)/714(9b) between the cut line 1000(9) and the attachment region 711(9a)/711(9b).

In FIG. 10E, the adhesive 712 (not visible in FIG. 10E) of the attachment region 711(13a)/711(13b) of the load restraint strip 710(13) has been placed into contact with the interior face 719(9a)/719(9b) of the attachment region 711(9a)/711(9b) of the load restraint strip 710(9). This affixes the attachment region 711(13a)/711(13b) to the attachment region 711(9a)/711(9b), thereby securing the attachment region 711(13a)/711(13b) of the load restraint strip 710(13) to the cargo wall 7 via the attachment region 711(9a)/711(9b) of the load restraint strip 710(9) and the attachment region 711(5a)/711(5b) of the load restraint strip 710(5). Although not shown, the adhesive 715 of the load restraint strip 710(13) may be affixed to the interior face 401 to support the tail 714(13a)/714(13b) of the load restraint strip 710(13). In FIG. 10F, the tail 714(13a)/714(13b) has been severed along a cut line 1000 (13), leaving the attachment region 711(13a)/711(13b) secured to the wall face 401 (via the attachment region 711(9a)/711(9b) and the attachment region 711(5a)/711(5b)) and a segment of the tail 714(13a)/714(13b) between the cut line 1000 (13) and the attachment region 711(13a)/711(13b).

In FIG. 10G, and as shown by the broken line 1001 (b), the inter-bonded attachment region portions 711(5b), 711(9b), and 711(13b), as well as the segments of tails 714(5b), 714(9b), and 714(13b), have been removed. A worker removed those portions and segments, in a manner similar to that shown in FIG. 9, by grasping the segments of tails 714(5b), 714(9b), and 714(13b) and pulling so as to both tear along the separation zones 878(5), 878(9), and 878(13) and exert a peel/tensile force on the portion of the adhesive 712 securing the attachment region portion 711(5b) to the wall face 401. In FIG. 10H, and as shown by the broken line 1001 (a), the inter-bonded attachment region portions 711(5a), 711(9a), and 711(13a), as well as the segments of tails 714(5a), 714(9a), and 714(13a), have been removed. A worker similarly removed those portions and segments by grasping the segments of tails 714(5a), 714(9a), and 714(13a) and pulling so as to exert a peel/tensile force on the portion of the adhesive 712 securing the attachment region portion 711(5a) to the wall face 401.

Although the example of FIGS. 10A-10H shows a two-step removal of inter-bonded attachment regions from three load restraint strips having separation zones, a similar two step removal may be performed for removal of inter-bonded attachment regions from two load restraint strips having separation zones, or for removal of inter-bonded attachment regions from four, five, six, or more load restraint strips having separation zones.

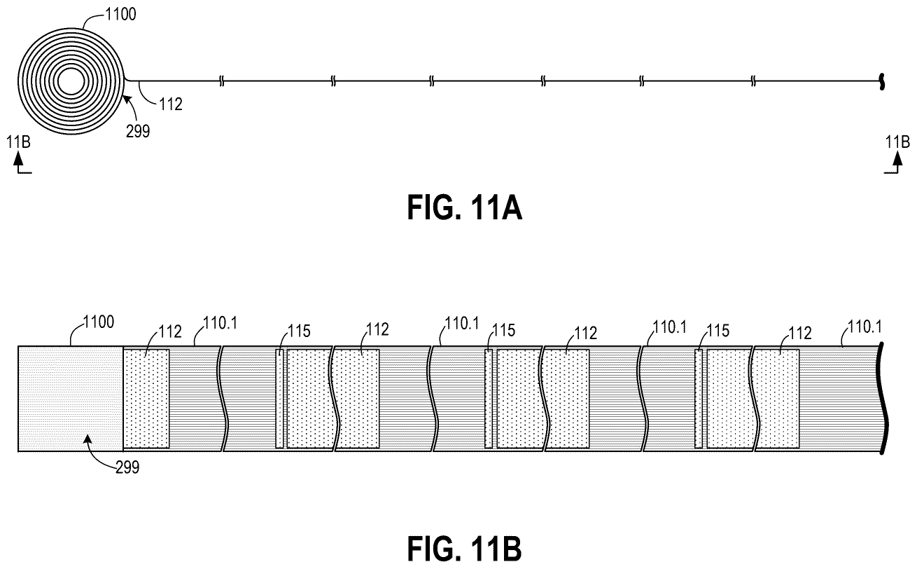

FIGS. 11A and 11B show a partially unrolled roll 1100 of load restraint strips 110.1. Each of the load restraint strips 110.1 may lack a release paper liner 293a and/or a release paper liner 293b, but may otherwise be the same as (or similar to, and/or may comprise variations such as those described for) the load restraint strip 110. Accordingly, reference numbers or individual elements of the load restraint strip 110 are used for the same or similar elements of the load restraint strips 110.1.

In the roll 1100, for many lengths of load restraint strips 110.1 and diameters of rolls 1100, and because of the absence of a release paper liner 293a, the adhesive 112 of a load restraint strip 110.1 is in contact with the interior face 299 of that same load restraint strip 110.1. For example, and as shown in FIGS. 11A and 11B, the load restraint strip 110.1 closest to the roll 1100 is not fully unrolled and a portion of its adhesive 112 is in contact with its interior face 299. Similarly, and because the load restraint strips 110.1 lack release paper liners 293b, the adhesive 115 of a load restraint strip 110.1 in the roll 1100 is in contact with the interior face 299 of that same load restraint strip.

For large rolls (e.g., greater than approximately 4 feet in diameter for load restraint strip 110.1 having a length L_{W} of 12 feet), at least a portion of the adhesive 112 of a load restraint strip 110.1 may contact an interior face 299 of a different load restraint strip 110.1 in the roll. Similarly, for large rolls, at least a portion of the adhesive 115 of a load restraint strip 110.1 may contact an interior face 299 of a different load restraint strip 110.1 in the roll.

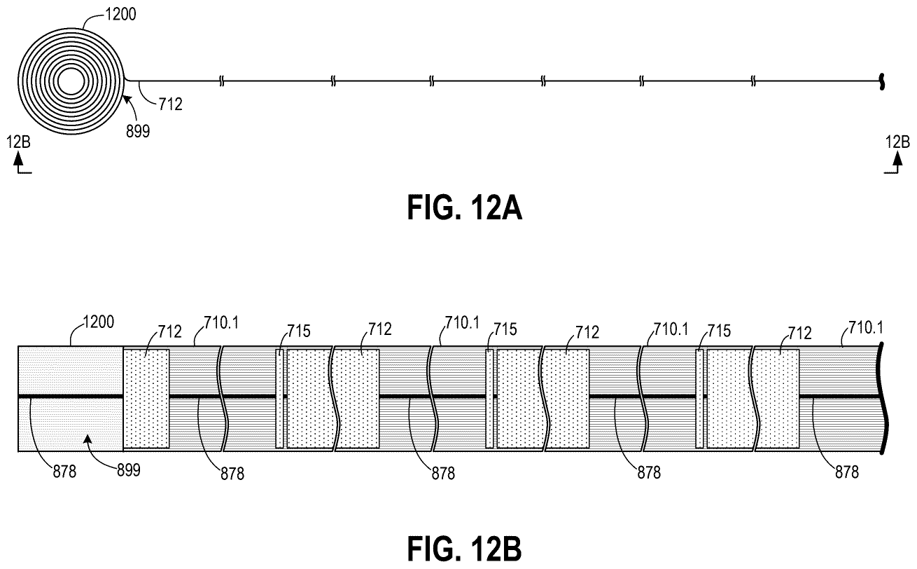

FIGS. 12A and 12B show a partially unrolled roll 1200 of load restraint strips 710.1 that comprise separation zones 878. Each of the load restraint strips 710.1 may lack a release paper liner 893a and/or a release paper liner 893b, but may otherwise be the same as (or similar to, and/or may comprise variations such as those described for) the load restraint strip 710. Accordingly, reference numbers or individual elements of the load restraint strip 710 are used for the same or similar elements of the load restraint strips 710.1.

In the roll 1200, for many lengths of load restraint strips 710.1 and diameters of rolls 1200, and because of the absence of a release paper liner 893a, the adhesive 712 of a load restraint strip 710.1 is in contact with the interior face 899 of that same load restraint strip 710.1. For example, and as shown in FIGS. 12A and 12B, the load restraint strip 710.1 closest to the roll 1200 is not fully unrolled and a portion of its adhesive 712 is in contact with its interior face 899. Similarly, and because the load restraint strips 710.1 lack release paper liners 293b, the adhesive 715 of a load restraint strip 710.1 in the roll 1200 is in contact with the interior face 899 of that same load restraint strip.

For large rolls (e.g., greater than approximately 4 feet in diameter for load restraint strip 710.1 having a length L_{W} of 12 feet), at least a portion of the adhesive 712 of a load restraint strip 710.1 may contact an interior face 899 of a different load restraint strip 710.1 in the roll. Similarly, for large rolls, at least a portion of the adhesive 715 of a load restraint strip 710.1 may contact an interior face 899 of a different load restraint strip 710.1 in the roll.

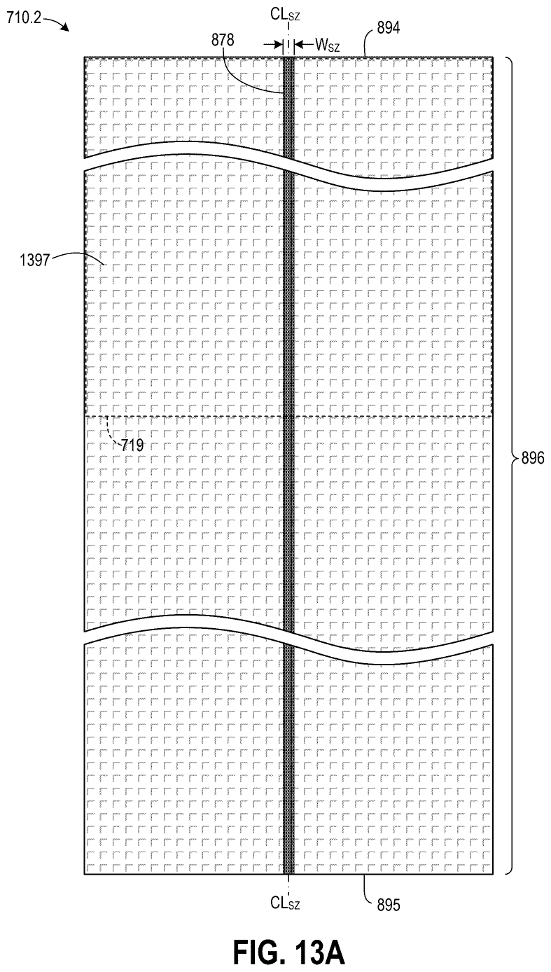

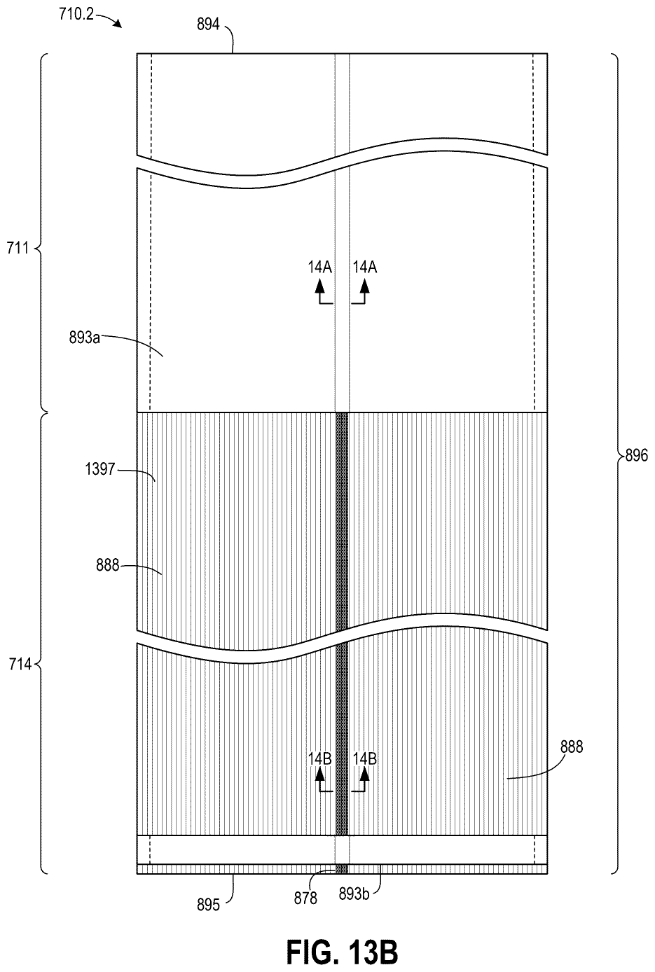

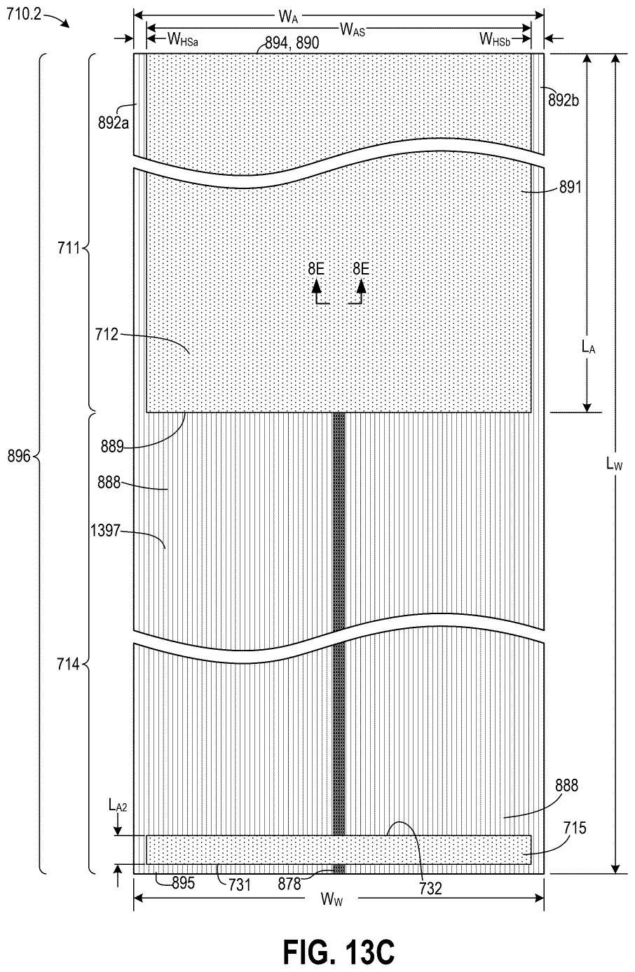

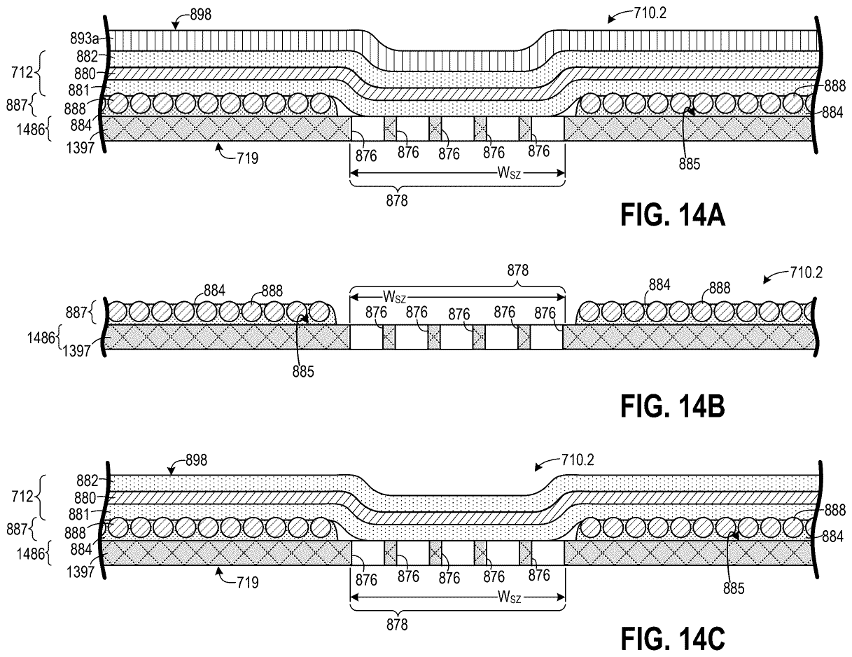

FIG. 13A is a partially schematic plan view showing an interior face of an example load restraint strip 710.2 that comprises a longitudinally-extending separation zone 878. The load restraint strip may comprise a band 1397 that forms a base layer of the load restraint strip 710.2. The band 710.2 may comprise a stitchbond fabric, another type of non-woven fabric, a woven fabric, a knitted fabric, a paper, or other type of material. The load restraint strip 710.2 may otherwise be the same as (or similar to, and/or may comprise variations such as those described for) the load restraint strip 710. Accordingly, reference numbers or individual elements of the load restraint strip 710 are used for the same or similar elements of the load restraint strips 710.2. FIG. 13B is a partially schematic plan view showing an exterior face of the load restraint strip 710.2 in a lined configuration. FIG. 13C is another partially schematic plan view showing the exterior face of the load restraint strip 710.2, but with the release paper liner 893a removed to expose an adhesive layer 712 and the release paper liner 893b removed to expose an adhesive layer 715. FIG. 14A is a partially schematic, truncated cross-sectional view of the load restraint strip 710.2 taken from the location indicated in FIG. 13B. The structure shown at the left and right sides of FIG. 14A extends, throughout the adhesive subregion 891, to the handling regions 892a and 892b. In the handling regions 892a and 892b, the load restraint strip 710.2 may have a structure that is the same as (or similar to, and/or may comprise variations such as those described for) the structure of the handling regions 292a and 292b, but with the base layer comprising the band 1397 instead of the band 297. FIG. 14B is a partially schematic, truncated cross-sectional view of the load restraint strip 710.2 taken from the location indicated in FIG. 13B. FIG. 14C is a partially schematic, truncated cross-sectional view of the load restraint strip 710.2 taken from the location indicated in FIG. 13C. The structure shown at the left and right sides of FIG. 14C extends, throughout the adhesive subregion 891, to the handling regions 892a and 892b. The regions between edges of the adhesive 715 and the edges of the load restraint strip 710.2 may have a structure that is the same as (or similar) the structure of the handling regions 892a and 892b.

The foregoing has been presented for purposes of example. The foregoing is not intended to be exhaustive or to limit features to the precise form disclosed. The examples discussed herein were chosen and described in order to explain principles and the nature of various examples and their practical application to enable one skilled in the art to use these and other implementations with various modifications as are suited to the particular use contemplated. The scope of this disclosure encompasses, but is not limited to, any and all combinations, subcombinations, and permutations of structure, operations, and/or other features described herein and in the accompanying drawing figures.

1. A load restraint strip comprising:
a polymer film base layer extending continuously from a first end of the load restraint strip to a second end of the load restraint strip and from a first side edge of the load restraint strip to a second side edge of the load restraint strip, wherein
a length of the base layer, from the first end to the second end, is greater than a width of the base layer from the first side edge to the second side edge,
a first face of the base layer forms an exposed face of the load restraint strip, and
the base layer comprises, in a separation zone that extends from the first end and that is located between the first side edge and the second side edge, one or more rows of perforations that extend through the base layer from the first face to an opposite second face of the base layer;
a reinforcement layer comprising a first reinforcement zone, extending from the first side edge to a first side of the separation zone and comprising a first plurality of substantially parallel strands bonded to the second face of the base layer, and a second reinforcement zone, extending from a second side of the separation zone to the second side edge and comprising a second plurality of substantially parallel strands bonded to the second face of the base layer; and
an adhesive layer bonded to the reinforcement layer and located in an adhesive region near the first end, wherein a length of the adhesive region is less than the length of the base layer.

2. The load restraint strip of claim 1, wherein reinforcement strands are absent from the separation zone.

3. The load restraint strip of claim 1, wherein the polymer film of the base layer comprises: polyethylene (PE), polyethylene terephthalate (PET), biaxially-oriented polypropylene (BOPP), polypropylene (PP), high density polyethylene (HDPE), medium density polyethylene (MDPE), low density polyethylene (LDPE).

4. The load restraint strip of claim 1, wherein the length of the adhesive region is less than half of the length of the base layer, and wherein the separation zone extends from the first end to the second end.

5. The load restraint strip of claim 1, wherein the separation zone extends along a centerline of the base layer.

6. The load restraint strip of claim 1, wherein the one or more rows of perforations comprise at least 5 rows of perforations.

7. The load restraint strip of claim 1, wherein the one or more rows of perforations comprise a plurality of rows of perforations and wherein a width of the separation zone is approximately 0.5 inches.

8. The load restraint strip of claim 1, wherein the first face of the base layer comprises a surface treatment configured to promote adhesion.

9. The load restraint strip of claim 1, wherein the load restraint strip is wound on a roll, wherein the adhesive layer lacks a release liner, and wherein the adhesive layer is in contact with the first face.

10. The load restraint strip of claim 1, further comprising a second adhesive layer bonded to the reinforcement layer and located near the second end, wherein a portion of an exterior face of the load restraint strip separates the adhesive layer and the second adhesive layer.

11. The load restraint strip of claim 1, wherein a length of the load restraint strip is at least 9 feet, a width of the load restraint strip is at least 16 inches, and a length of the adhesive layer is between 2 and 6 feet.

12. A load restraint strip comprising:
a base layer extending continuously from a first end of the load restraint strip to a second end of the load restraint strip and from a first side edge of the load restraint strip to a second side edge of the load restraint strip, wherein
a length of the base layer, from the first end to the second end, is greater than a width of the base layer from the first side edge to the second side edge,
a first face of the base layer forms an exposed face of the load restraint strip, and
the base layer comprises, in a separation zone that extends from the first end and that is located between the first side edge and the second side edge, one or more rows of perforations that extend through the base layer from the first face to an opposite second face of the base layer;
a reinforcement layer comprising a first reinforcement zone, extending from the first side edge to a first side of the separation zone and comprising a first plurality of substantially parallel strands bonded to the second face of the base layer, and a second reinforcement zone, extending from a second side of the separation zone to the second side edge and comprising a second plurality of substantially parallel strands bonded to the second face of the base layer; and
an adhesive layer bonded to the reinforcement layer and located in an adhesive region near the first end, wherein
a length of the load restraint strip is at least 9 feet, a width of the load restraint strip is at least 16 inches, and a length of the adhesive layer is between 2 and 6 feet.

13. The load restraint strip of claim 12, wherein the separation zone extends from the first end to the second end, and wherein reinforcement strands are absent from the separation zone.

14. The load restraint strip of claim 12, wherein the one or more rows of perforations comprise a plurality of rows of perforations and wherein a width of the separation zone is approximately 0.5 inches.

15. The load restraint strip of claim 12, further comprising a second adhesive layer bonded to the reinforcement layer and located in an adhesive region near the second end, wherein a portion of an exterior face of the load restraint strip separates the adhesive layer and the second adhesive layer.

16. The load restraint strip of claim 12, wherein the base layer comprises a polymer film.

17. A load restraint strip comprising:
a polymer film base layer extending continuously from a first end of the load restraint strip to a second end of the load restraint strip and from a first side edge of the load restraint strip to a second side edge of the load restraint strip, wherein
a length of the base layer, from the first end to the second end, is greater than a width of the base layer from the first side edge to the second side edge,
a first face of the base layer forms an exposed face of the load restraint strip, and
the base layer comprises, in a separation zone that extends from the first end and that is located between the first side edge and the second side edge, one or more rows of perforations that extend through the base layer from the first face to an opposite second face of the base layer;
a reinforcement layer comprising a first reinforcement zone, extending from the first side edge to a first side of the separation zone and comprising a first plurality of substantially parallel strands bonded to the second face of the base layer, and a second reinforcement zone, extending from a second side of the separation zone to the second side edge and comprising a second plurality of substantially parallel strands bonded to the second face of the base layer;
a first adhesive layer bonded to the reinforcement layer and located in an adhesive region near the first end; and
a second adhesive layer bonded to the reinforcement layer and located in an adhesive region near the second end, wherein a portion of an exterior face of the load restraint strip separates the first adhesive layer and the second adhesive layer.

18. The load restraint strip of claim 17, wherein the separation zone extends from the first end to the second end, and wherein reinforcement strands are absent from the separation zone.

19. The load restraint strip of claim 17, wherein the one or more rows of perforations comprise a plurality of rows of perforations and wherein a width of the separation zone is approximately 0.5 inches.

20. The load restraint strip of claim 17, wherein the first face of the base layer comprises a surface treatment configured to promote adhesion.
